(19) United States
(12) Patent Application Publication
(10) Pub. No.: US 2006/0078492 A1
(43) Pub. Date: Apr. 13, 2006

(54) Perovskite titanium-containing composite oxide particle, production process and uses thereof

(75) Inventors: Tadatoshi Kurozumi, Chiba (JP); Akihiko Shirakawa, Chiba (JP); Hitoshi Yokouchi, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 11/246,373

(22) Filed: Oct. 11, 2005

Related U.S. Application Data
(63) Continuation-in-part of application No. PCT/JP04/05154, filed on Apr. 9, 2004.

(30) Foreign Application Priority Data
Apr. 11, 2003 (JP) 2003-107663
Jun. 10, 2003 (JP) 2003-165393
Nov. 14, 2003 (JP) 2003-384664

(51) Int. Cl. C01G 23/00

(52) U.S. Cl. 423/598; 264/621

(57) ABSTRACT

The present invention provides a perovskite titanium-containing composite oxide fine particle represented by the formula: (A1_{X}A2_{(1-X)})_{Y}TiO_{3±δ} (wherein 0≦X≦1, 0.98≦Y≦1.02, 0≦δ≦0.05, A1 and A2 each is an atom selected from a group consisting of Ca, Sr, Ba, Pb and Mg and are different from each other), wherein the specific surface area is from 1 to 100 m²/g and the D2/D1 value is from 1 to 10.

### CROSS-REFERENCE TO RELATED APPLICATIONS

This is an application filed pursuant to 35 U.S.C. Section 111(a) with claiming the benefit of U.S. provisional application Ser. No. 60/463,335 filed Apr. 17, 2004 and U.S. provisional application Ser. No. 60/478,829 filed Jun. 17, 2003 under the provision of 35 U.S.C. 111(b), pursuant to 35 U.S.C. Section 119(e)(1).

### TECHNICAL FIELD

The present invention relates to a perovskite titanium-containing composite oxide fine particle for use in electronic materials such as dielectric material, piezoelectric material, pyroelectric material, multilayer ceramic capacitor and thin-film material, and a production process thereof.

More specifically, the present invention relates to a perovskite titanium-containing composite oxide fine particle having a solid solution ratio controlled to an arbitrary value and having a small particle size, a narrow particle size distribution, excellent dispersibility, high crystallinity and less impurities, and also relates to a production process thereof.

### BACKGROUND ART

Perovskite-structure titanium-containing composite oxides represented by the formula ABO₃ exhibit excellent electrical properties such as dielectricity, piezoelectricity and pyroelectricity and therefore, these are widely used as an electronic material.

The perovskite-structure titanium-containing composite oxide represented by (A1_{X}A2_{(1-X)})_{Y}TiO_{3±δ} has a perovskite crystal structure such that the A site is occupied by A1 atom and A2 atom and the B site is occupied by titanium. In this case, the electrical properties differ depending on the solid solution ratio of the A1 atom to the A2 atom and perovskite-structure titanium-containing composite oxides having a solid solution ratio controlled to an arbitrary value are used as various electronic materials. For example, those with the solid solution ratio controlled to have high dielectricity are used for dielectric filters, dielectric antennas, dielectric resonators, dielectric duplexers, capacitors, phase shifters and various capacitor materials including multilayer ceramic capacitor, and those with the solid solution ratio controlled to have high piezoelectricity are used for multilayer piezoelectric actuators.

The method for forming a perovskite-structure titanium-containing composite oxide fine particle into an electronic material is not particularly limited. For example, the fine particle and a solvent are mixed to obtain a slurry or a paste and then formed into a thin-film material or a porcelain by a method such as molding/sintering or sheeting.

In order to cope with recent needs for downsizing, weight reduction and higher performance of electronic parts, development of a perovskite-structure titanium-containing composite oxide fine particle having high crystallinity and a narrow particle size distribution with a small particle size is demanded.

Furthermore, in the perovskite-structure titanium-containing composite oxide fine particle represented by the formula (A1_{X}A2_{(1-X)})_{Y}TiO_{3±δ}, the electrical properties vary depending on the solid solution ratio of A1 atom to A2 atom and on the ratio of the total of A1 atom and A2 atom to titanium and therefore, it is demanded to precisely control these ratios.

Also, all impurities adversely affect the electrical properties and therefore, a high-purity perovskite-structure titanium-containing composite oxide fine particle deprived of impurities is demanded. As for the method for producing a perovskite-structure titanium-containing composite oxide fine particle, a flux method is known. However, this method is disadvantageous in that not only the production cost becomes very high but also grinding is the only means for obtaining fine particles in this method, resulting in a broad particle size distribution and bad dispersibility of the obtained particles.

Other examples of the method for producing a titanium-containing composite oxide particle for use in electronic materials include a solid phase method where powders of an oxide or a carbonate used as starting material are mixed in a ball mill or the like and then reacted at a high temperature of about 800° C. or more to produce a titanium-containing composite oxide particle, an oxalic acid method where a composite oxalate is prepared and then thermally decomposed to obtain a titanium-containing composite oxide particle, a hydrothermal synthesis method of reacting starting materials in a water solvent at a high temperature under a high pressure to obtain a precursor, and an alkoxide method metal where alkoxide as starting material is hydrolyzed to obtain a precursor.

In addition, a method of reacting a hydrolysis product of titanium compound with a water-soluble barium in a strong alkali (see, European Patent No. 104002 (JP-B-3-39014) (the term “JP-B” as used herein means an “examined published Japanese patent application”)) and a method of reacting a titanium oxide sol with a barium compound in an aqueous strong alkali solution (see, European Patent No. 114803 (WO00/35811) and US Patent Publication No. 2003/0044347A1 (W03/004416)) are generally known. Improvements of these synthesis methods are being aggressively made.

The solid phase method has a problem in that despite low production cost, the produced titanium-containing composite oxide particle has a large particle size and when the particle is ground, the particle size becomes small but the particle size distribution is broadened and the molding density is not enhanced. Furthermore, the crystal structure is distorted by the grinding and a perovskite titanium-containing composite oxide particle suitable for the small-size and high-performance formation cannot be obtained.

In the oxalate method, although a particle smaller than in the solid phase method can be obtained, carbonic acid group originated in the oxalic acid remains and a large amount of hydroxy group derived from water entrapped inside also remains, which causes the electrical properties to decrease. Therefore, a titanium-containing composite oxide particle having excellent electrical properties cannot be obtained.

In the hydrothermal synthesis method, a fine particulate titanium-containing composite oxide can be obtained but this oxide has many defects due to remaining hydroxyl group attributable to water entrapped inside and a titanium-containing composite oxide having excellent electrical properties can be hardly obtained. Furthermore, the synthesis is performed under high-temperature high-pressure conditions and this causes a problem that exclusive equipment is necessary and the cost increases.

In the alkoxide method, a particulate titanium-containing composite oxide finer than in the hydrothermal synthesis method can be obtained. However, remaining hydroxyl group attributable to water entrapped inside results in many defects of the produced particle, and thus a titanium-containing composite oxide having excellent electrical properties can be hardly obtained. Further, the alkoxide method has another defect that carbonic acid group remains in the produced particle.

In European Patent No. 104002 (JP-B-3-39014), potassium hydroxide or sodium hydroxide is used as the alkali and therefore, a step of removing such an alkali after the reaction is necessary. In this step, dissolution of barium and entrapping of hydroxyl group take place and a titanium-containing composite oxide having high crystallinity can be hardly obtained.

Also, in these methods, a perovskite-structure titanium-containing composite fine particle controlled to an arbitrary ratio of A1 atom and A2 atom solid-dissolved is difficult to produce, because the starting material compounds differ in the reactivity. For example, in producing a barium.strontium titanate composite fine particle having solid-dissolved therein barium and strontium at an arbitrary ratio, the reactivity between the starting material barium compound and the titanium compound differs from the reactivity between the starting material strontium compound and the titanium compound and therefore, the raw material tends to remain or a mixture of barium titanate and strontium titanate is readily mingled in the product.

JP-A-2-188427, JP-A-4-16513, U.S. Pat. No. 4,677,083 (JP-A-60-155532) and JP-A-6-9219 disclose a method for producing a barium.strontium titanate composite fine particle. In JP-A-2-188427, a solid phase method using a carbonate controlled to have an arbitrary ratio of barium to strontium is employed and therefore, not only a step of producing a carbonate having that ratio is necessary but also the particle size distribution is disadvantageously broadened due to indispensable cracking. In JP-A-4-16513, not only expensive titanium alkoxide is necessary but also the crystal structure has many defects due to remaining hydroxyl group attributable to water entrapped inside and a titanium-containing composite oxide having excellent electrical properties can be hardly obtained. In U.S. Pat. No. 4,677,083 (JP-A-60-155532) and JP-A-6-9219, a step of removing by-product of a titanium compound and an alkali metal hydroxide must be conducted after the production reaction. In this step, dissolution of barium or strontium and entrapping of hydroxyl group take place and therefore, the ratio of barium to strontium is difficult to control to an arbitrary value and a titanium-containing composite oxide having high crystallinity can be hardly obtained.

Furthermore, these methods all are in need of improvements from the standpoint of providing a barium.strontium titanate composite fine particle having higher crystallinity and a narrow particle size distribution with a small particle size.

One example of titanium-base composite oxide having perovskite-type crystalline structure is calcium titanate which is widely used for temperature compensating porcelain capacitor material. Calcium titanate is also used as an additive for preventing the dielectric constant of a barium titanate-based high dielectric capacitor from abruptly changing at the Curie point. Therefore, similarly to other titanium-based composite oxides, development of a calcium titanate having a small particle size, superior dispersibility, high crystallinity and excellent electrical properties is demanded.

In European Patent No. 104002 (JP-A-59-45927) and JP-A-5-178617, a method of producing a spherical calcium titanate is disclosed, but it is demanded to provide a calcium titanate having higher crystallinity and more excellent electrical properties.

For example, when the technique disclosed in European Patent No. 1148030 (WO00/35811) or US Patent Publication No. 2003/0044347A1 (WO03/004416) is used, fine particles reduced in the number of sub-micron particles can be obtained at a relatively low cost. However, in order to achieve downsizing, reduction in weight and high-performance of electronic parts, it is demanded to provide a perovskite titanium-containing composite oxide particle reduced in the amount of impurities, wherein atoms on A-sites are solid-dissolved at an arbitrary ratio or a calcium titanate particle more reduced in the number of ultrafine particles (0.01 μm or less) or aggregated particles and ensured with superior dispersibility, high crystallinity and excellent electrical properties.

One of the objects of the present invention is to provide a perovskite titanium-containing composite oxide particle having a small particle size, a narrow particle size distribution, superior dispersibility, high crystallinity and excellent electrical properties, and production method therefor.

Another object of the invention is to provide a perovskite titanium-containing composite oxide fine particle reduced in the amount of impurities, wherein atoms on A-sites are contained at an arbitrary ratio and a calcium titanate particle reduced in the number of ultrafine particles or aggregated particles and having an extremely sharp particle size distribution.

### DISCLOSURE OF INVENTION

That is, the present invention comprises the following inventions.

(1) A perovskite titanium-containing composite oxide fine particle represented by the formula: (A1_{X}A2_{(1-X)})_{Y}TiO_{3±δ} (wherein 0≦X≦1, 0.98≦Y≦1.02, 0≦δ≦0.05, A1 and A2 each is an atom selected from a group consisting of Ca, Sr, Ba, Pb and Mg and are different from each other), wherein the specific surface area is from 1 to 100 m²/g and the D2/D1 value is from 1 to 10.

(2) The perovskite titanium-containing composite oxide fine particle as described in (1) above, comprising a single crystal of perovskite titanium-containing composite oxide.

(3) The perovskite titanium-containing composite oxide fine particle as described in (1) or (2) above, which has a tetragonal prism shape or a shape analogous to tetragonal prism.

(4) The perovskite titanium-containing composite oxide fine particle as described in (3) above, wherein the ratio of the long side to the short side of the crystal is from 1.1 to 6.

(5) The perovskite titanium-containing composite oxide fine particle as described in (3) or (4) above, wherein the long side of the crystal is extending to the unit cell (010) plane.

(6) The perovskite titanium-containing composite oxide fine particle as described in any one of (1) to (5) above, wherein D2/D1 value is from 1 to 3.

(7) The perovskite titanium-containing composite oxide fine particle as described in any one of (1) to (6) above, wherein D3/D2 value is from 0.1 to 0.9.

(8) The perovskite titanium-containing composite oxide fine particle as described in any one of (1) to (7) above, wherein the D4/D2 value is from 1.1 to 10.

(9) The perovskite titanium-containing composite oxide fine particle as described in any one of (1) to (8) above, wherein the compound represented by A1_{X}A2_{(1-X)})_{Y}TiO_{3±δ} is CaTiO₃ and the calcium-carbonate content is 3 mass % or less.

(10) The perovskite titanium-containing composite oxide fine particle as described in any one of (1) to (9) above, wherein the specific surface area is from 1 to 10 m²/g.

(11) The perovskite titanium-containing composite oxide fine particle as described in any one of (1) to (10) above, wherein calcining at any temperature of 900 to 1,200° C., the decrease in the specific surface area is 8 m²/g or less.

(12) The perovskite titanium-containing composite oxide fine particle as described in (1) above, wherein 0.2≦X≦0.8, 0.99≦Y≦1.01, 0≦δ≦0.03 and the fine particle is a single crystal.

(13) The perovskite titanium-containing composite oxide fine particle as described in (1) above, wherein A1 is Ba and A2 is Sr.

(14) The perovskite titanium-containing composite oxide fine particle as described in any one of (1) to (13) above, wherein the amount of alkali metal impurities is from 0 to 100 ppm and the amount of chlorine impurities is from 0 to 600 ppm.

(15) The perovskite titanium-containing composite oxide fine particle as described in any one of (1) to (14) above, wherein calcining for 0.1 to 3 hours at any temperature from 900 to 1,000° C., the percentage decrease in the specific surface area is 90% or less.

(16) The perovskite titanium-containing composite oxide fine particle as described in any one of (1) to (15) above, wherein the shape becomes a dice form after calcining for 0.1 to 3 hours at any temperature from 900 to 1,200° C.

(17) The perovskite titanium-containing composite oxide fine particle as described in any one of (1) to (16) above, wherein the amount of carbonate is 3 mass % or less.

(18) The perovskite titanium-containing composite oxide fine particle as described in any one of (1) to (17) above, wherein when 1.5 g of the perovskite titanium-containing composite oxide particle is immersed in 45 ml of pure water, the total extraction amount of A1 atom and A2 atom per unit surface area is from 0 to 2 μmol/m².

(19) A process for producing the perovskite titanium-containing composite oxide fine particle as described in any one of (1) to (18) above, wherein a titanium oxide sol and a metal salt are added into an alkaline aqueous solution comprising basic compound, and then react.

(20) The process for producing the perovskite titanium-containing composite oxide fine particle as described in (19) above, wherein the metal salt is added in a weight of 10 to 10,000 times by mass the saturated solubility in the alkaline solution.

(21) The process for producing the perovskite titanium-containing composite oxide fine particle as described in (19) above, wherein the calcium salt is a hydroxide.

(22) The process for producing the perovskite titanium-containing composite oxide fine particle as described in (19) above, comprising controlling the concentration of a carbonic acid group in the reaction solution to 500 ppm or less in terms of CO₂.

(23) The process for producing the perovskite titanium-containing composite oxide fine particle as described in (19) above, comprising a step of boiling the reaction system at 100° C. or more for 2 hours or more

(24) The process for producing the perovskite titanium-containing composite oxide fine particle as described in (19) above, which comprises a step of removing impurities as gas by evaporation and/or thermal decomposition under atmospheric or reduced pressure in the temperature range from room temperature to calcining temperature.

(25) The process for producing the perovskite titanium-containing composite oxide fine particle as described in (19) above, wherein the titanium oxide sol is obtained by hydrolyzing titanium compounds in an acidic solution.

(26) The process for producing the perovskite titanium-containing composite oxide fine particle as described in (19) above, wherein the titanium oxide sol comprises a brookite crystal.

(27) The process for producing the perovskite titanium-containing composite oxide fine particle as described in (19) above, wherein the basic compound is a substance which becomes gas by evaporation, sublimation and/or thermal decomposition under atmospheric or reduced pressure.

(28) The process for producing the perovskite titanium-containing composite oxide fine particle as described in (27) above, wherein the basic compound is an organic base.

(29) The process for producing the perovskite titanium-containing composite oxide fine particle as described in (19) above, wherein the basic compound is a tetramethylammonium hydroxide.

(30) A process for producing a perovskite titanium-containing composite oxide fine particle, comprising reacting A1(OH)₂ and A2(OH)₂ at an arbitrary ratio with titanium oxide of 0.98 to 1.02 mol times the total mol of A1(OH)₂ and A2(OH)₂ in an alkaline solution comprising a basic compound and having a pH of 10 or more, wherein A1 and A2 each represent an atom selected from a group consisting of Ca, Sr, Ba, Pb and Mg, continuing the reaction until the total concentration of A1 ion and A2 ion in the reaction solution becomes 1/1,000 or less of the amount added and after the completion of reaction, removing the basic compound as gas by evaporation, sublimation and/or thermal decomposition under atmospheric or reduced pressure in the temperature range from room temperature to calcining temperature.

(31) The process for producing a perovskite titanium-containing composite oxide fine particle as described in (30) above, wherein the molar ratio of A1(OH)₂ to A2(OH)₂ is from 0.2 to 0.8.

(32) The process for producing a perovskite titanium-containing composite oxide fine particle as described in (30) above, comprising controlling the concentration of a carbonic acid group in the reaction solution to a range from 0 to 500 ppm in terms of CO₂.

(33) The process for producing a perovskite titanium-containing composite oxide fine particle as described in (30) above, wherein the titanium oxide comprises a brookite crystal.

(34) The process for producing a perovskite titanium-containing composite oxide fine particle as described in (30) above, wherein the titanium oxide is obtained by hydrolyzing a titanium compound in an acidic solution.

(35) The process for producing a perovskite titanium-containing composite oxide fine particle as described in (30) above, wherein the basic compound is a substance which becomes gas by evaporation, sublimation and/or thermal decomposition under atmospheric or reduced pressure.

(36) The process for producing a perovskite titanium-containing composite oxide fine particle as described in (30) above, wherein the basic compound is an organic base.

(37) The process for producing a perovskite titanium-containing composite oxide fine particle as described in (30) above, wherein the basic compound is a tetramethylammonium hydroxide.

(38) A dielectric material comprising the perovskite titanium-containing composite oxide fine particle as described in any one of (1) to (18) above.

(39) A paste comprising the perovskite titanium-containing composite oxide fine particle as described in any one of (1) to (18) above.

(40) A slurry comprising the perovskite titanium-containing composite oxide fine particle as described in any one of (1) to (18) above.

(41) A thin-film material comprising the perovskite titanium-containing composite oxide fine particle as described in any one of (1) to (18) above.

(42) A dielectric porcelain comprising the perovskite titanium-containing composite oxide fine particle as described in any one of (1) to (18) above.

(43) A pyroelectric porcelain comprising the perovskite titanium-containing composite oxide fine particle as described in any one of (1) to (18) above.

(44) A piezoelectric porcelain comprising the perovskite titanium-containing composite oxide fine particle as described in any one of (1) to (18) above.

(45) A capacitor comprising the dielectric porcelain as described in (42) above.

(46) An electronic device comprising at least one member selected from the group consisting of the thin-film material described in (41) above, the porcelain described in (42) to (44) above and the capacitor as described in (45) above.

(47) A sensor comprising one or more thin-film material described in (41) above or porcelain as described in (42) to (44) above.

(48) A dielectric film comprising the perovskite titanium-containing composite oxide fine particle as described in any one of (1) to (18) above.

(49) A capacitor comprising the dielectric film as described in (48) above.

The perovskite titanium-containing composite oxide particle in the present invention is a perovskite titanium-containing composite oxide fine particle represented by the formula:
(A1_{X}A2_{(1-X)})_{Y}TiO_{3±δ}
(in the formula, 0≦X≦1, 0.98≦Y≦1.02, 0≦δ≦0.05, and A1 and A2 are different from each other and each of them is selected from a group consisting of Ca, Sr, Ba, Pb and Mg)
wherein the specific surface area is from 1 to 100 m²/g and assuming that the average primary particle size is D1 and the average secondary particle size is D2, the D2/D1 value is from 1 to 10. This perovskite titanium-containing composite oxide particle is characterized by having a small particle size, a narrow particle size distribution, superior dispersibility, high crystallinity and excellent electrical properties.

The composite oxide as used herein is not a mere mixture but means a solid solution where atoms are solid-dissolved at a constant ratio. The crystal structure can be confirmed by the X-ray diffraction measurement. Also, the ratio of A1 atom to A2 atom in the perovskite titanium-containing composite oxide particle can be determined from peak positions in the X-ray diffraction diagram.

Hereinbelow, (1) perovskite titanium-containing composite oxide particle comprising a solid solution ratio of A1 to A2 which is arbitrarily controllable and (2) a calcium titanate particle (CaTiO₃:compound wherein A1 is Ca, both X and Y represent 1 and δ is 0) having a sharp particle size distribution with fewer ultra-fine particles and fewer agglomerated particles are specifically described.

(1) Perovskite Titanium-Containing Composite Oxide Particle Comprising a Arbitrarily Controllable Solid-Solution Ratio of A1 to A2

In the perovskite titanium-containing composite oxide in the present invention, the value of X representing the solid solution ratio is within a range of 0≦X≦1, preferably 0.2≦X≦0.8, more preferably 0.3≦X≦0.7. The solid solution ratio X is preferably adjusted to provide desired electrical properties. For example, the dielectric constant of barium titanate at room temperature is about 1,600 and that of strontium titanate is about 260. By adjusting the solid solution ratio of barium to strontium, a barium.strontium titanate adjusted to exhibit a desired dielectric constant value at room temperature can be obtained.

The ratio of the total molar number of A1 atom and A2 atom to the molar number of titanium, namely, the ratio (Y) can be in the range of 0.98≦Y≦1.02, preferably 0.99≦Y≦1.01, more preferably 0.995≦Y≦1.005, and this ratio is adjusted to provide desired electrical properties. The ratio (Y) is preferably closer to 1, because less defects are produced and higher crystallinity is obtained.

The ratio (3±δ) of oxygen can be in the range of 0≦δ≦0.1, preferably 0≦δ≦0.05, more preferably 0≦δ≦0.03, and this ratio is adjusted to provide desired electrical properties. The δ is preferably closer to 0, because less defects are produced and higher crystallinity is obtained.

In order to improve the electrical properties of the perovskite-structure titanium-containing composite oxide fine particle in the present invention, other compounds may be added and used and this causes no problem.

The perovskite-structure titanium-containing composite oxide fine particle in the present invention can have a specific surface area of 1 to 100 m²/g, preferably from 5 to 70 m²/g, more preferably from 10 to 50 m²/g. The specific surface area can be measured by the BET method. In general, for downsizing an electronic material, the particle must have a specific surface area of 1 m²/g or more, but if the specific surface area exceeds 100 m²/g, the particles readily undergo aggregation and the powder becomes difficult to deal with.

The perovskite titanium-containing composite oxide fine particle in the present invention is a fine particle having a narrow particle size distribution and excellent dispersibility with less aggregation. Here, the average primary particle size D1 can be determined according to formula (1) from the specific surface area obtained by the BET method for a particle in terms of a sphere:
D1=6/ρS (1)
wherein ρ is particle density and S is a specific surface area of particle.

The secondary particle size of aggregated particles can be determined by dispersing perovskite titanium-containing composite oxide fine particles in a solvent and measuring the particle size by means of a particle size distribution analyzer. Generally, a suitable particle size distribution analyzer can be selected according to the particle size distribution range measured. The secondary particle size of the perovskite titanium-containing composite oxide fine particle in the present invention can be measured, for example, by a centrifugal precipitation method, a Microtrack method, an electrozone method (Coulter counter) and a light scattering method, and from a standpoint of the good sensitivity of the particle, a light scattering method is preferably employed for the measurement. The particle size distribution on the weight basis of secondary particles can be measured by this method and the average particle size (or particle size at 50% from the minimum) D2 can be determined. The particle size determined here is a size of a particle in terms of a sphere.

The minimum of the D2/D1 value of the average secondary diameter D2 to the average primary particle size D1 is theoretically 1 when both of the primary particle and the secondary particle measured are spherical. A larger D2/D1 value reveals that the primary particles are more aggregated and the dispersibility is more decreased. The perovskite-structure titanium-containing composite oxide fine particle in the present invention can have a D2/D1 value of 1 to 10, preferably from 1 to 9, more preferably from 1 to 8.

The perovskite titanium-containing composite oxide fine particle in the present invention can be a single crystal and this can be confirmed by the observation through a transmission electron microscope.

Also, the perovskite titanium-containing composite oxide fine particle in the present invention can have reduced impurities. The alkali metal content can be from 0 to 100 ppm, preferably from 0 to 80 ppm, more preferably from 0 to 60 ppm. The amount of chlorine impurities can be from 0 to 600 ppm, preferably from 0 to 400 ppm, more preferably from 0 to 200 ppm.

Furthermore, the perovskite titanium-containing composite oxide fine particle in the present invention can less grow in the calcining step and the specific surface area can be less decreased. The reason therefor is not clearly known, but it is assumed to be caused by that the particulate titanium-containing composite oxide in the present invention contains very few ultrafine particles with specific surface area exceeding 100 m²/g. For example, when the perovskite titanium-containing composite oxide fine particle in the present invention is calcined at a temperature of 900 to 1,000° C. for 0.1 to 3 hours, preferably from 1 to 3 hours, the percentage decrease in the specific surface area can be 90% or less, preferably 80% or less, more preferably 60% or less. Assuming that when the specific surface area of dry powder is S1 and the specific surface area after calcining at a temperature of 900 to 1,000° C. for 0.1 to 3 hours, preferably from 1 to 3 hours, is S2, the percentage decrease in the specific surface area can be determined according to formula (2):
(S1−S2)/S1×100 (2)

The shape of the perovskite titanium-containing composite oxide fine particle in the present invention can be confirmed by enlarged observation through a scanning electron microscope. In the present invention, for example, in most cases of the barium.strontium titanate composite fine particle, the shape is almost spherical and when the composition ratio of barium in A-site (X value) is in a range of 0 to 0.8, particularly in a range of 0.35 to 0.65, the shape can become a dice-like shape after calcining at a temperature of 900 to 1,200° C. The reason why the shape changes into a dice form is not clearly known but it is assumed to be caused by its high crystallinity. More specifically, strontium has an atomic radius smaller than that of barium and is readily rearranged by calcining and therefore, when the composition ratio of strontium (1−X) is in a range of 0.2 to 1 (i.e., X value is in a range of 0 to 0.8), a dice form results.

The dice form as used herein means a shape close to a cube. In the present invention, when the composition ratio of barium in A-site (X value) is from 0 to 0.8, 50% or more (preferably 70% or more, more preferably 80% or more) of fine particles can be formed into dice-like shape.

The smaller the total amount of carbonates contained in the perovskite titanium-containing composite oxide fine particle, the more preferable. The content of carbonates can be generally 3 mass % or less, preferably 2 mass % or less, more preferably within a range from 0 to 1 mass %. The amount of carbonates (e.g., barium carbonate, calcium carbonate, strontium carbonate, lead carbonate) contained in the perovskite titanium-containing composite oxide fine particle can be confirmed by measuring the infrared absorption spectrum. For example, in the case of a barium.strontium titanate composite fine particle, the amount of carbonates can be determined by comparing peak intensities in the vicinity of 880 cm⁻¹ of standard barium carbonate and strontium carbonate with the peak intensity of barium.strontium titanate in the present invention.

When the perovskite titanium-containing composite oxide fine particle is immersed in pure water, the total extracted amount of A1 ion and A2 ion per unit area of the fine particle can be from 0 to 2 μmol/m², preferably from 0 to 1 μmol/m², more preferably from 0 to 0.5 μmol/m². Although the reason is not clearly known, it is presumed that the perovskite titanium-containing composite oxide fine particle in the present invention has high crystallinity and small contents of ionic A1 atom and A2 atom and therefore, the amount of ions eluting into pure water is not large.

The amount of ion extracted as used herein means a total amount of respective ions per unit area of the perovskite titanium-containing composite oxide fine particle and is determined according to formula (3):
a×L/G×S (3)
wherein

a: a concentration (ppm) of ion extracted in pure water after the extraction test,

L: an amount L (g) of pure water used in the extraction test,

G: a weight (g) of perovskite titanium-containing composite oxide fine particle used in the extraction test, and

S: a specific surface area (m²/g) of perovskite titanium-containing composite oxide fine particle.

In the determination of the total extracted amount of respective ions, the perovskite titanium-containing composite oxide fine particle in the present invention is charged into ion exchanged water in a nitrogen glove box and after tightly stoppering, thoroughly stirred, the supernatant is separated and the amount of ion extracted in pure water can be measured by an ICP emission method, an atomic absorption method or the like. The stirring time varies depending on the stirring conditions and therefore, is not particularly limited. The stirring time can be determined by the time point when the amount value of ion extracted in pure water reaches saturation, which is observed by time-interval measurement.

The process for producing a perovskite titanium-containing composite oxide fine particle in the present invention is described below by taking the case of producing barium.strontium titanate as an example, however, the present invention is not limited to barium.strontium titanate.

In inert gas atmosphere, barium hydroxide and strontium hydroxide are dissolved in an alkaline solution containing a basic compound and having a pH of about 10 or more, preferably about 13 or more. Subsequently, a titanium oxide sol is charged thereinto and reacted until the total amount of barium and strontium in the reaction solution becomes 1/1,000 or less of the amount charged.

After the completion of reaction, the basic compound is removed as gas by evaporation, sublimation and/or thermal decomposition under atmospheric or reduced pressure in the temperature range from room temperature to calcining temperature and thereby, a barium.strontium titanate composite fine particle is produced.

In the production of a perovskite titanium-containing composite oxide fine particle in the present invention, an alkaline solution containing a basic compound is preferred. The reason therefor is not clearly known, but it is presumed that as the alkalinity is higher, each ion (in this case, barium ion or strontium ion) more readily reacts with titanium oxide. The pH of the solution can be 10 or more, preferably 13 or more, more preferably 14 or more. The upper limit in the amount of a basic compound charged is the saturated solubility of the basic compound in water.

In the process for producing a perovskite titanium-containing composite oxide fine particle in the present invention, hydroxides can be used at an arbitrary ratio and thereby, a corresponding perovskite titanium-containing composite oxide fine particle can be produced. In the case of a barium.strontium titanate composite fine particle, barium hydroxide and strontium hydroxide can be used at an arbitrary ratio and thereby, a barium.strontium titanate composite in a corresponding ratio can be produced. Also, the titanium oxide sol can be blended to give a predetermined ratio of the total of barium and strontium to titanium. The ratio between barium hydroxide and strontium hydroxide is not particularly limited.

For example, when barium hydroxide, strontium hydroxide and titanium oxide with a ratio of 5 mol (barium hydroxide):5 mol (strontium hydroxide):10 mol (titanium oxide) are charged, a Ba_{0.5}Sr_{0.5}TiO₃ composite fine particle can be produced, and when barium hydroxide, strontium hydroxide and titanium oxide with a ratio of 6 mol (barium hydroxide):4 mol (strontium hydroxide):10 mol (titanium oxide) are charged, a Ba_{0.6}Sr_{0.4}TiO₃ composite fine particle can be produced.

Then, the reaction can be continued until the total concentration of respective ions in the reaction solution becomes 1/1,000 or less, preferably 1/2,000 or less, more preferably 1/5,000 or less, still more preferably 1/10,000 or less, of the amount charged. By performing the reaction in this way, the reaction rate to a perovskite titanium-containing composite oxide can be increased, the unreacted raw materials such as hydroxide and titanium oxide can be decreased, and the purity and crystallinity can be elevated.

The amount of each ion in the solution after reaction can be determined by removing solid contents and quantitating the amount of each ion in the reaction solution by an ICP emission method, an atomic absorption method, or the like.

In the present invention, the amount of each ion in the solution after reaction can be determined according to formula (4):
([A1′]+[A2′])×L2/([A1]+[A2]) (4)
wherein

[A1′], [A2′]: each is a molar concentration (mol/ml) obtained by converting the mass concentration of A1 ion or A2 ion in the solution after reaction,

[A1], [A2]: each is a molar number (mol) of hydroxide charged for the reaction, and

L2: an amount (ml) of reaction solution.

After the completion of reaction, the basic compound can be removed under atmospheric or reduced pressure in the temperature range from room temperature to calcining temperature and the impurities can be removed as gas by evaporation, sublimation and/or thermal decomposition, whereby each ion can be prevented from eluting out from the surface of the perovskite titanium-containing composite oxide particle in the present invention and the crystallinity can be enhanced.

Industrially, the reaction can be most commonly performed under heating with stirring. The carbonic acid group (including, as carbonic acid species, CO₂, H₂CO₃, HCO₃⁻ and CO₃²⁻) in the reaction solution reacts with barium hydroxide or strontium hydroxide to produce stable barium carbonate or strontium carbonate. The barium carbonate or strontium carbonate does not react with titanium oxide and remains as an impurity in the perovskite titanium-containing composite oxide particle. Therefore, controlling the concentration (in terms of CO₂; unless otherwise indicated, the same applies in the following) of carbonic acid group in the reaction solution enables stable production of high-purity perovskite titanium-containing composite oxide particle.

The concentration in terms of CO₂ in the reaction solution can be from 0 to 500 ppm by mass, preferably from 0 to 200 ppm by mass, more preferably from 0 to 100 ppm by mass. In order to reduce the concentration of carbonic acid group in the reaction solution, the water before dissolving the basic compound is preferably heat-treated and thereby decarboxylated immediately before starting the production process. Also, the reaction solution is alkaline and readily absorbs CO₂ in air. Therefore, the reaction is preferably performed in a closed system or while blowing inert gas so as not to contact the reaction solution with air.

In order to elevate the crystallinity, the reaction temperature is preferably as high as possible. In the case of elevating the reaction temperature, a hydrothermal reaction from 100° C. to the critical temperature of solution may be performed, but this might require equipment ensuring the safety of autoclave. Therefore, the reaction is preferably performed by boiling the reaction system at 100° C. or more under atmospheric pressure and keeping the temperature. Furthermore, mechanical stirring is preferred because the raw materials are mixed with each other. The reaction time can be usually 2 hours or more, preferably 3 hours or more, more preferably 4 hours or more.

The impurity adversely affecting the electrical properties also includes trace components such as metal ion and anion.

The trace impurity ions such as metal ion and anion may be removed by various methods, for example, by subjecting the slurry after the completion of reaction to a treatment such as electrodialysis, ion exchange, water washing, acid washing and osmotic membrane. However, according to such a method, barium and the like contained in the perovskite titanium-containing composite oxide particle can be ionized simultaneously with the impurity ions and sometimes partially dissolved in the slurry and this not only makes it difficult to solid-dissolve barium and strontium at a desired ratio but also brings about generation of defects in the crystal and in turn reduction of the crystallinity. Furthermore, the reaction solution is alkaline and therefore, in such a treatment, carbon dioxide in air can be readily mingled, as a result, the carbonate contained in the perovskite titanium-containing composite oxide particle disadvantageously increases.

Accordingly, selection of raw materials reduced in impurities and prevention of impurities from mingling at the reaction or calcining are preferred. In addition, the impurities are preferably removed as gas by evaporation, sublimation and/or thermal decomposition under atmospheric or reduced pressure in the temperature range from room temperature to calcining temperature.

The calcining is generally performed for enhancing the crystallinity of titanium-containing composite oxide while the impurities can be removed as gas by evaporation, sublimation and/or thermal decomposition in the calcining. Examples of impurities removable in this method may include organic base such as organic amine having a low carbon number, hydroxides of ammonium salt and trace amount of organic compounds or carbonate contained as impurities in raw materials. The calcining is usually performed at 350 to 1,200° C. The calcining atmosphere is not particularly limited and the calcining is usually performed in air or under reduced pressure.

From the standpoint of decreasing the heat energy at the calcining or enhancing the crystallinity, the calcining is preferably performed after subjecting the slurry to solid-liquid separation. The solid-liquid separation comprises steps of precipitation, concentration and filtration of particles, and/or drying and milling. Through the precipitation, concentration and filtration, the impurities dissolved in the solution can be removed. In order to change the precipitation rate or filtration rate, a coagulant or a dispersant may be used. In that case, it is preferable to use a coagulant or dispersant which is removable as gas by evaporation, sublimation and/or thermal decomposition.

The drying step can be performed for the purpose of evaporating the water content while some kinds of basic compound or impurity can be partially or entirely removed by evaporation, sublimation and/or thermal decomposition in this step. The drying can be performed by the method such as reduced-pressure drying, hot-air drying and freeze drying. The drying is usually performed at room temperature to 350° C. for 1 to 24 hours. The drying atmosphere is not particularly limited, but the drying is usually performed in air or inert gas or under reduced pressure. Thereafter, the particle may be cracked by an appropriate method.

The barium salt, strontium salt and the like for use in the present invention each is used as a hydroxide. As long as the salt is a hydroxide, it may be an anhydrous salt or a hydrate and this is not particularly limited.

In general synthesis of the perovskite-structure titanium-containing composite oxide, the oxygen ratio (3+δ) in formula: (A1_{X}A2_{(1-X)})_{Y}TiO_{3±δ} changes in respective steps of reaction, solid-liquid separation, drying, calcining and the like to cause defects in the crystal structure and the electrical properties tend to decrease. However, in the present invention, the above-described production process is employed and thereby, the δ value can be made very small.

The titanium oxide sol for use in the present invention is not particularly limited but a titanium oxide sol containing a brookite crystal or a titanium oxide sol obtained by hydrolyzing a titanium salt in an acidic solution is preferred.

As long as a brookite crystal is contained, the titanium oxide sol may comprise brookite titanium oxide alone or may contain rutile or anatase titanium oxide. In the case of containing rutile or anatase titanium oxide, the ratio of brookite titanium oxide in the titanium oxide is not particularly limited but is usually from 1 to 100 mass %, preferably from 10 to 100 mass %, more preferably from 50 to 100 mass %. This is because the crystalline particle more readily forms a simple particle than the amorphous particle and therefore, is preferred for realizing excellent dispersibility of the titanium oxide particle in a solvent and the brookite titanium oxide is particularly excellent in dispersibility. The reason therefor is not clearly known, however it is presumed that the zeta potential of brookite titanium oxide at pH 2 which is higher than the zeta potential of the rutile or anatase type plays some roles.

Examples of the method for solid phase producing a titanium oxide particle comprising a brookite crystal include a production method of heat-treating an anatase titanium oxide particle to obtain a titanium oxide particle comprising a brookite crystal, and a liquid-phase production method of neutralizing or hydrolyzing a solution comprising a titanium compound such as titanium tetrachloride, titanium trichloride, titanium alkoxide and titanium sulfate to obtain a titanium oxide sol having dispersed therein titanium oxide particles.

In the method of producing a titanium-containing composite oxide particle starting from a titanium oxide particle comprising a brookite crystal, it is preferable to use as titanium oxide particle a particle comprising a titanium oxide sol obtained by hydrolyzing a titanium salt in an acidic solution, since the sol has a small particle size and excellent dispersibility. More specifically, a method of adding titanium tetrachloride to hot water at 75 to 100° C. and hydrolyzing the titanium tetrachloride while controlling the chloride ion concentration at a temperature of 75° C. to the boiling point of solution to obtain a brookite crystal-containing titanium oxide particle as a titanium oxide sol (see, JP-A-11-43327) and a method of adding titanium tetrachloride to hot water at 75 to 100° C. and hydrolyzing the titanium tetrachloride in the presence of one or both of nitrate ion and phosphate ion while controlling the total concentration of chloride ion, nitrate ion and phosphate ion at a temperature of 75° C. to the boiling point of solution to obtain a brookite crystal-containing titanium oxide particle as a titanium oxide sol (see U.S. Pat. No. 6,627,336 (WO99/58451) are preferred.

The thus-obtained titanium oxide particle usually has a primary particle size of 1 to 100 nm, preferably from 3 to 50 nm, more preferably from 5 to 20 nm. If the primary particle size exceeds 100 nm, the titanium-containing composite oxide particle produced by using the titanium oxide particle as starting material may be increased in the particle size and not suitable for functional materials such as dielectric material and piezoelectric material, whereas if the primary particle size is less than 1 nm, the handling may be difficult in the step of producing the titanium oxide particle.

In the case of using a titanium oxide sol obtained by hydrolyzing a titanium salt in an acidic solution, the titanium oxide is not limited in the crystal form and not limited to brookite crystal form.

When a titanium salt such as titanium tetrachloride and titanium sulfate is hydrolyzed in an acidic solution, the reaction rate can be more suppressed than in the reaction using a neutral or alkaline solution, as a result, particles having a simple particle size can be formed and a titanium oxide sol having excellent dispersibility can be obtained. Furthermore, anion such as chloride ion and sulfate ion is hardly entrapped into the inside of the produced titanium oxide particle and therefore, when a titanium-containing composite oxide particle is produced, the mingling of anion into the particle can be decreased.

On the other hand, if the hydrolysis is preformed in a neutral or alkaline solution, the reaction rate might increase and many nuclei might be generated at the initial stage, as a result, a titanium oxide sol having bad dispersibility despite a small particle size might be obtained and the particles might be aggregated like whiskers. When a titanium-containing composite oxide particle is produced starting from such a titanium oxide sol, the particle obtained exhibits bad dispersibility despite a small particle size. Also, anion may be readily mingled into the inside of the titanium oxide particle and this anion may be difficult to remove in later steps.

The method of hydrolyzing a titanium salt in an acidic solution to obtain a titanium oxide sol is not particularly limited as long as the solution can be kept acidic, but a method of hydrolyzing titanium tetrachloride as a starting material in a reactor equipped with a reflux condenser and preventing the chlorine generated at that time from escaping, thereby keeping the solution acidic (see, JP-A-11-43327) is preferred.

The concentration of titanium salt in the acidic solution is preferably from 0.01 to 5 mol/L. If the concentration exceeds 5 mol/L, the hydrolysis proceeds at a high reaction rate and the obtained titanium salt may have a large particle size and bad dispersibility, whereas if it is less than 0.01 mol/L, the concentration of titanium oxide obtained may be reduced and the productivity may be low.

The method of adding the titanium oxide sol is not particularly limited, however, for preventing the aggregation of titanium oxide sol and obtaining barium.strontium titanate having excellent dispersibility, the titanium oxide sol is preferably added little by little into a reaction solution obtained by adding a barium.strontium salt at least in a saturated solubility or more to an alkaline solution containing a basic compound, heating and stirring the solution. Examples of the method of charging the titanium oxide sol little by little include a method of adding dropwise the titanium oxide sol by using a pump or the like and a method of injecting the titanium oxide sol into a solution.

The basic compound for use in the present invention is not particularly limited but is preferably a substance which becomes gas by evaporation, sublimation and/or thermal decomposition under atmospheric or reduced pressure. Examples thereof include organic bases such as organic amine having high solubility in ammonia or water and a low carbon number, and hydroxide of ammonium salt.

Among these, a hydroxide of ammonium salt is preferred for its properties of acting as a strong base due to its high dissociation degree when dissolved in water and not vaporizing at the reaction. On the other hand, an organic amine having high solubility in ammonia or water and a low carbon number is weak as a base and awkward due to its low boiling point.

Industrially known examples of the hydroxide of ammonium salt include choline and tetramethylammonium hydroxide (TMAH), and these are available at a low cost. Particularly, tetramethylammonium hydroxide is being used in the electronic industry and it is preferable to use this compound not only in that the commercially available product of the compound contains little impurities such as metal ion and the like but also in that the compound can be thermally decomposed at 135 to 140° C. and removed as gas.

The barium.strontium titanate composite fine particle in the present invention can be also produced by using an inexpensive inorganic compound such as lithium hydroxide, sodium hydroxide and potassium hydroxide, however, the basic compound which becomes gas is more preferred.

The basic compound is not particularly limited. One basic compound may be used singly or two or more compounds may also be used by mixing them at an arbitrary ratio and this causes no problem.

(2) Calcium Titanate Particle with Fewer Ultra-Fine Particles and Agglomerated Particles (CaTiO₃)

In the perovskite titanium-containing composite oxide particle in the present invention, the calcium titanate, wherein A1 is calcium, X and Y represent 1 and δ is 0, is characterized by having a perovskite crystal structure and a tetragonal prism shape or a shape analogous to tetragonal prism, being a single crystal, being reduced in the number of ultra-fine particles or aggregated particles, and having a sharp particle size distribution and excellent dispersibility.

The shape of the calcium titanate can be confirmed by enlarged observation through a scanning electron microscope. The calcium titanate powder having a perovskite crystal structure and a tetragonal prism shape or a shape analogous to tetragonal prism may have a columnar hexahedral shape where the bottom face has a shape close to a square and the side face has a shape close to a rectangle. Respective faces can be intersecting at nearly right angles but in some cases, at least one corner can be slightly chamfered and rounded or chipped. The number of particles where respective faces are intersecting at right angles occupies 80% or more, preferably 90% or more, more preferably 95% or more, of the entire powder. In the case where the corner is slightly chamfered and rounded, the radius of curvature can be 10 μm or more.

When the calcium titanate particle can be observed by a scanning electron microscope, most particles may have a short-side length of 0.2 to 0.6 μm and a long-side length of 0.2 to 1.2 μm. The percentage of such a particle can be 80% or more, preferably 85% or more, more preferably 90% or more.

The ratio of the long side to the short side can be determined by measuring the maximum long side and the minimum short side every each calcium titanate particle and according to the production process of a calcium titanate in the present invention, a particle having a tetragonal prism shape with the ratio of long side to short side being 1.1 to 6 can be stably produced. A larger the ratio of long side to short side of the calcium titanate crystal may imply that the particle is growing more in the longitudinal direction of the perovskite structure expressing electrical properties, and this is preferred.

It can be confirmed by the analysis of an electron beam diffraction image through a transmission electron microscope that the calcium titanate is a single crystal and that in this single crystal, the long side is extending to the unit cell (010) plane.

Being a single crystal means that the crystallinity is very high. The long side extending to the unit cell (010) plane direction may indicate that the perovskite structure of expressing electrical properties is growing in the longitudinal direction. Therefore, the electrical properties such as dielectricity, piezoelectricity and pyroelectricity are very excellent.

The calcium titanate may have a specific surface area of 1 to 10 m²/g, preferably from 1 to 8 m²/g, more preferably from 1 to 6 m²/g. The specific surface area can be measured by the BET method. For downsizing an electronic material, the particle may have a specific surface area of 1 m²/g or more, but if the specific surface area exceeds 100 m²/g, the particles readily undergo aggregation with each other and the powder might become difficult to deal with.

The calcium titanate is a fine particle having a sharp particle size distribution and excellent dispersibility with less aggregation. Here, the average primary particle size D1 can be determined according to the above-mentioned formula (1).

The particle size distribution on the weight basis of secondary particles can be measured by this method and the average particle size D2, the particle size D3 at 10% from the minimum and the particle size D4 at 90% from the minimum can be determined. The particle size determined here is a size of a particle in terms of a sphere.

The calcium titanate may have a D2/D1 ratio of 1 to 3, preferably from 1 to 2.7, more preferably from 1 to 2.5.

The particle size distribution of secondary particles can be obtained from D3/D2 ratio and D4/D2 ratio in the particle size distribution of the calcium titanate. As each value is closer to 1, the particle size distribution of secondary particles becomes sharper and this is preferred.

In the present invention, the D3/D2 value may be from 0.1 to 0.9, preferably from 0.15 to 0.7, more preferably from 0.2 to 0.5. The D4/D2 value is from 1.1 to 10, preferably from 1.2 to 8, more preferably from 1.4 to 5.

The amount of calcium carbonate contained in the calcium titanate may be from 0 to 3 mass %, preferably from 0 to 2 mass %, more preferably from 0 to 1 mass %. The amount of the calcium carbonate contained in the calcium titanate can be confirmed by measuring the infrared absorption spectrum. Specifically, the amount of calcium carbonate can be determined by comparing peak area intensity in the vicinity of 880 cm⁻¹ of standard calcium carbonate with the peak area intensity of calcium titanate of the present invention.

Also, the calcium titanate in the present invention is characterized in that the particle less grows in the calcining step and the specific surface area is less decreased. In general, a fine particulate titanium-based composite oxide readily grows at the calcining step and the specific surface area tends to be greatly decreased, but the calcium titanate in the present invention does not have such a tendency. For example, when the dried calcium titanate powder is calcined at 900 to 1,200° C., the decrease in the specific surface area is 8 m²/g or less, preferably 5 m²/g or less, more preferably 2 m²/g or less.

Next, the production process in the present invention is described below. In the process for producing a calcium titanate in the present invention, a titanium oxide sol and a calcium salt are added to the saturated solubility or to a higher concentration into an alkaline aqueous solution comprising a basic compound and reacted to produce a calcium titanate.

Industrially, the reaction is most commonly performed under heating with stirring. The carbonic acid group (including, as carbonic acid species, CO₂, H₂CO₃, HCO₃⁻ and CO₃²⁻) in the reaction solution reacts with barium salt or strontium salt to produce stable barium carbonate or strontium carbonate. The barium carbonate or strontium carbonate does not react with titanium oxide and remains as an impurity in the perovskite titanium-containing composite oxide particle. Therefore, controlling the concentration (in terms of CO₂; unless otherwise indicated, the same applies in the following) of carbonic acid group in the reaction solution enables stable production of high-purity perovskite titanium-containing composite oxide particle.

The reaction conditions as to the concentration of carbonic acid group and controlling thereof, reaction temperatures, reaction times, removal of impurities and calcining are almost the same as those specified in describing the production process of (1) perovskite titanium-containing composite oxide particle mentioned above, however, the reaction time here may be 3 hours or more, preferably 4 hours or more and more preferably 6 hours or more.

In the present invention, a calcium salt may be added in a saturated solubility or more in an alkaline solution comprising at least a basic compound. The reaction mechanism is not clearly known but it is presumed that at the initial stage of reaction, the calcium salt dissolved in the solution begins to react with the titanium oxide sol to produce ultrafine particulate calcium titanate and thereafter, the remaining part of calcium salt which is undissolved at the initial stage of the reaction also gradually starts to get dissolved to react with the titanium oxide sol to produce calcium titanate while allowing the newly produced calcium titanate to grow on the initially produced calcium titanate. By virtue of this reaction mechanism, not only ultrafine particles are reduced but also a narrow particle size distribution and a particle size suitable for small-size electronic parts can be obtained. Furthermore, the solubility of calcium salt is very low and therefore, the newly produced calcium titanate particle is considered to come to have a very small particle size at a very low rate and form a stable shape before the growth, as a result, a single crystal particle having a shape analogous to tetragonal prism can be obtained.

The amount of the calcium salt added is not particularly limited as long as it is a saturated solubility or more, but if the amount added in an alkaline aqueous solution is small, ultrafine particulate calcium titanate is readily mingled and a calcium titanate having a sharp particle size distribution cannot be obtained. In this meaning, the concentration of the calcium salt is preferably higher, but if the amount charged in an alkaline aqueous solution is excessively large, the calcium salt may not be uniformly mixed in the alkaline aqueous solution or the viscosity of the solution becomes high.

Accordingly, the calcium salt is preferably charged in a weight of 10 to 10,000 times the saturated solubility in an alkaline aqueous solution.

The calcium salt for use in the present invention is not particularly limited as long as it is sparingly soluble in an alkaline aqueous solution, and a hydroxide, a nitrate, a sulfate, a halide or a salt with an organic material such as carboxylic acid and alcohol may be used. One of these compounds may be used alone or two or more compounds may also be used by mixing them at an arbitrary ratio.

In particular, the calcium salt is preferably a hydroxide, because calcium hydroxide is sparingly soluble in water and more sparingly soluble in an alkaline aqueous solution. The hydroxide is also advantageous in that the anion in calcium hydroxide can be easily removed as gas.

Those which form a stable chelate with calcium, such as calcium salt of ethylenediaminetetraacetic acid, are not preferred, because the saturated solubility becomes high and calcium titanate may not be produced.

In the production of the calcium titanate in the present invention, an alkaline solution comprising a basic compound is preferred. As the alkalinity is higher, the calcium salt is more difficult to dissolve and this is preferred. The pH of the solution is preferably 13 or more, more preferably 14 or more. The upper limit in the amount of a basic compound added may be the saturated solubility of the basic compound in water.

According to the present invention, as the basic compound for use in this process, those usable in the process of producing (1) perovskite titanium-containing composite oxide fine particle mentioned above can be used.

The unreacted calcium salt and titanium oxide sol can be hardly fractionated and removed from the calcium titanate after the reaction. Therefore, the titanium oxide sol can be blended in such an amount that a predetermined ratio of calcium and titanium in the calcium titanate may be obtained at the completion of the reaction.

The titanium oxide sol for use in the present invention is not particularly limited but a titanium oxide sol containing a brookite crystal or a titanium oxide sol obtained by hydrolyzing a titanium salt in an acidic solution is preferred. Those exemplified in the process of producing (1) perovskite titanium-containing composite oxide particle mentioned above can be used.

The method of adding the titanium oxide sol is not particularly limited, but for preventing the aggregation of titanium oxide sol and obtaining calcium titanate having excellent dispersibility, the titanium oxide sol is preferably added little by little into a reaction solution obtained by adding a calcium salt in a saturated solubility or more to an alkaline solution comprising a basic compound, heating and stirring the solution. Examples of the method of adding the titanium oxide sol little by little include a method of adding dropwise the titanium oxide sol by using a pump or the like and a method of injecting the titanium oxide sol into a solution.

The thus-produced calcium titanate can have a small particle size with a narrow particle size distribution, superior dispersibility, high crystallinity and excellent electrical properties, and this calcium titanate can be formed into a dielectric porcelain, a pyroelectric porcelain, a piezoelectric porcelain or a thin-film material. The dielectric porcelain or a thin-film material can be used as a material of capacitor or used for sensor.

The perovskite titanium-containing composite oxide particle in the present invention can be also used as a slurry or a paste by mixing the particle alone or in combination with additives and other materials, in one or more solvent comprising water, an existing inorganic binder or an existing organic binder.

The electrical properties of the perovskite titanium-containing composite oxide fine particle in the present invention can be evaluated by using an impedance analyzer or the like after calcining or sintering its shaped article under appropriate conditions, such as disc obtained by adding various additives such as sintering aid to the particle and shaping it, or thin film obtained by adding various additives to a slurry or paste containing the particle and shaping it.

A film having a high dielectric rate can be obtained by dispersing a filler comprising the perovskite titanium-containing composite oxide fine particle in the present invention in one or more selected from a group consisting of thermoplastics resin and thermo-setting resin.

In the case where the filler further contains materials other than the perovskite titanium-containing composite oxide fine particle in the present invention, one or more members selected from a group consisting of alumina, titania, zirconia and tantalum oxide can be used.

Thermoplastic resin and thermo-setting resin usable in the present invention are not particularly limited, and resins conventionally used can be employed. Preferred examples of thermo-setting resin include epoxy resin, polyimide resin, polyamide resin and bistriazine resin. Preferred examples of thermoplastic resin include polyolefin resin, styrene resin and polyamide.

For the purpose of uniformly dispersing the filler comprising the perovskite titanium-containing composite oxide fine particle in the present invention in at least one kind of thermoplastic resin and/or thermo-setting resin, it is preferable to prepare a slurry in advance by dispersing the filler in a solvent or a mixture of solvent and the above described resin composition.

The method for preparing a slurry by dispersing a filler in a solvent or a mixture of a solvent and a resin composition is not particularly limited, however, it is preferable that the preparation method involve a wet cracking step.

The solvent is not particularly limited and any solvent conventionally used may be used. Examples thereof include methylethylketone, toluene, ethyl acetate, methanol, ethanol, N,N-dimethylformamide, N,N-dimethylacetamide, N-methylpyrrolidone and methylcellosolve, which may be used singly or two or more thereof may be used in mixture.

In preparing a slurry where a filler is dispersed in a solvent or a mixture of a solvent and a resin composition as above-described, it is preferable to blend in a coupling agent therewith. The coupling agent is not particularly limited and any coupling agent conventionally used may be used. Examples thereof include silane coupling agent, titanate-base coupling agent and aluminate-base coupling agent. The hydrophilic group contained in the coupling agent reacts with active hydrogen present on the surface of the filler comprising the perovskite titanium-containing composite oxide fine particle of the present invention to provide coating on the surface, and thus the dispersibility of the filler in the solvent is enhanced. With an appropriate selection of the coupling agent, the hydrophobic group contained in the coupling agent may enhance compatibility with resin. For example, in a case where epoxy resin is used as the resin, a silane coupling agent having a functional group such as monoamino, diamino, cationic styryl, epoxy, mercapto, anilino and ureide, or a titanate-base coupling agent having a functional group such as phosphite, amino, diamino, epoxy and mercapto, is preferably used. Further, in a case where polyimide resin is used, a silane coupling agent having a functional group such as monoamino, diamino and anilino, or a titanate-base coupling agent having a functional group such as monoamino and diamino, is preferably used. These coupling agents may be used singly or two or more of them may be used in mixture.

The amount of the coupling agent is not particularly limited as long as the amount allows the coupling agent to react to provide coating on the partial or whole surface of the perovskite titanium-containing composite oxide fine particle of the present invention. However, too excessive an amount of the coupling agent is not preferable, since the part remaining unreacted may adversely affect the slurry while too small an amount may reduce the coupling effect. Therefore, it is desirable that the amount of the coupling agent be chosen according to the particle size of the filler comprising the perovskite titanium-containing composite oxide fine particle of the present invention, its specific surface area, and the kind of the coupling agent used, so that the filler may be dispersed uniformly, and the preferable range of the amount is from 0.05 to 20 weight %.

In order to complete reaction between the hydrophilic group in the coupling agent and active hydrogen present on the surface of the filler comprising the perovskite titanium-containing composite oxide fine particle of the present invention, it is preferable that in the production process, heat treatment be performed after preparation of the slurry. The heating temperature and heating time are not particularly limited, however, it is preferable that the heat treatment be performed at a temperature of 100 to 150° C. for 1 to 3 hours. When the boiling point of the solvent is 100° C. or less, the heating temperature is adjusted to the boiling point or less and accordingly the heating time is lengthened.

### BRIEF DESCRIPTION OF DRAWINGS

FIG. 1 is a X-ray diffraction spectrum of Ba_{0.6}Sr_{0.4}TiO₃ powder particle produced in Example 1 before calcining.

FIG. 2 is an image of Ba_{0.6}Sr_{0.4}TiO₃ powder particle observed by a scanning electron microscope produced in Example 1 before calcining.

FIG. 3 is an image of Ba_{0.6}Sr_{0.4}TiO₃ powder particle observed by scanning electron microscope produced in Example 1 after calcining.

FIG. 4 is a X-ray diffraction spectrum of Ba_{0.6}Sr_{0.4}TiO₃ powder particle produced in Example 1 after calcining.

FIG. 5 is an image of Ba_{0.6}Sr_{0.4}TiO₃ powder particle observed by a transmission electron microscope produced in Example 1 after calcining.

FIG. 6 is an electron diffraction image of Ba_{0.6}Sr_{0.4}TiO₃ powder particle produced in Example 1 after calcining.

FIG. 7 is a X-ray diffraction spectrum of Ba_{0.4}Sr_{0.6}TiO₃ powder particle produced in Example 2.

FIG. 8 is a X-ray diffraction spectrum of SrTiO₃ powder particle produced in Example 3.

FIG. 9 is an X-ray diffraction spectrum of the calcium titanate powder obtained in Example 8.

FIG. 10 is an image of the calcium titanate powder observed by a scanning electron microscope obtained in Example 8.

FIG. 11 is an X-ray diffraction spectrum of the calcium titanate powder obtained in Example 9.

FIG. 12 is an image of the calcium titanate powder observed by a scanning electron microscope obtained in Example 9.

FIG. 13 is an image and an electron diffraction of the calcium titanate powder observed by a transmission electron microscope obtained in Example 9.

FIG. 14 is an image of Ba_{0.95}Ca_{0.05}TiO₃ powder particle observed by a scanning electron microscope produced in Example 17 before calcining.

FIG. 15 is a X-ray diffraction spectrum of Ba_{0.95}Ca_{0.05}TiO₃ powder particle produced in Example 17 before calcining.

FIG. 16 is an image of Ba_{0.95}Ca_{0.05}TiO₃ powder particle observed by a scanning electron microscope produced in Example 17 after calcining.

FIG. 17 is a X-ray diffraction spectrum of Ba_{0.95}Ca_{0.05}TiO₃ powder particle produced in Example 17 after calcining.

### BEST MODE FOR CARRYING OUT THE INVENTION

The present invention is described in detail below by referring to Examples and Comparative Examples, however, the present invention is not limited only to these Examples.

### EXAMPLE 1

An aqueous solution having a titanium tetrachloride (produced by Sumitomo Titanium Corporation, purity: 99.9%) concentration of 0.25 mol/L was charged into a reactor with a reflux condenser and heated to the vicinity of boiling point while keeping the solution acidic by preventing chloride ion from escaping. The solution was kept at that temperature for 60 minutes and thereby the titanium tetrachloride was hydrolyzed to obtain a titanium oxide sol. The obtained titanium oxide sol was dried at 110° C. and the crystal type was examined by an X-ray diffraction device (RAD-B Rotor Flex) manufactured by Rigaku Corporation and found to be a brookite titanium oxide.

Into a reactor with a reflux condenser, 456 g of an aqueous 20 mass % tetramethylammonium hydroxide solution (TMAH) (produced by Sachem Showa K.K., concentration of carbonic acid group: 60 ppm or less), 75.7 g of barium hydroxide octahydrate and 42.5 g of strontium hydroxide octahydrate were charged in a nitrogen stream. The obtained aqueous solution having a pH of 14 was boiled with stirring and to the reactor, 213 g of a sol having a titanium oxide concentration of 15 mass % obtained by precipitating and concentrating the sol prepared above from which chlorine ion was removed by an electrodialyser to 500 ppm was added dropwise at a speed of 7 g per minute.

The boiling was continued for 4 hours with stirring. Subsequently, the heating was stopped while continuing the stirring and the resulting solution was allowed to cool to 50° C. and then filtered under reduced pressure. Thereafter, 1 ml of concentrated nitric acid and water in an amount to make 50 ml were added to 1 g of the filtrate and the obtained solution was measured by the ICP emission method, as a result, the amount of barium ion in the filtrate was 2 ppm and the amount of strontium ion was 1 ppm. The reaction was continued until the total concentration of barium ion and strontium ion in the solution after reaction, calculated according to formula (3), became 1/1,000 or less of the amount charged.

The obtained cake was dried at 300° C. for 5 hours to obtain a dry powder. The ratio of the actual yield to the theoretical yield calculated from the amounts of titanium oxide and barium hydroxide used in the reaction was 99.9%.

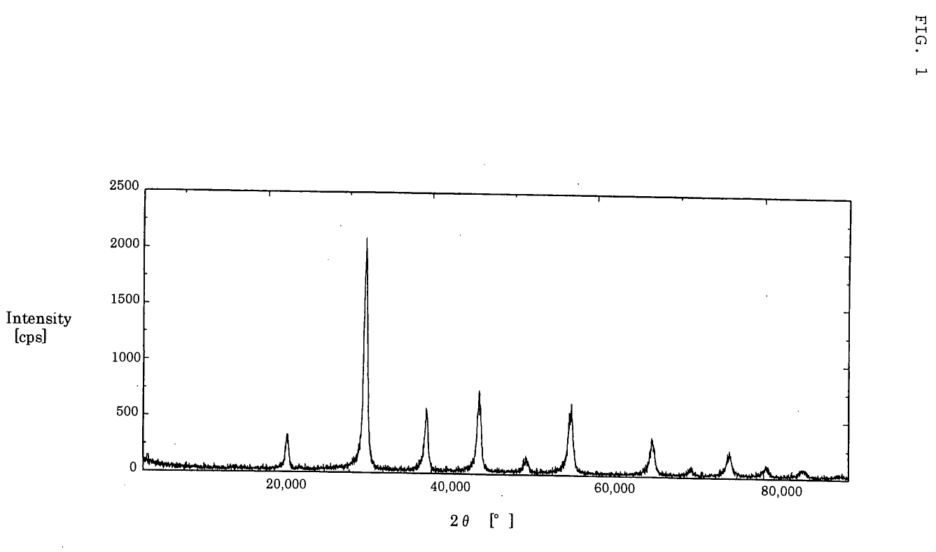

The dry powder was cracked in a mortar and the obtained powder particle was evaluated by using an X-ray diffraction device (RAD-B Rotor Flex) manufactured by Rigaku Corporation. The Rietveld analysis conducted by using the X-ray diffraction peak revealed that the obtained powder particle was a perovskite Ba_{0.6}Sr_{0.4}TiO₃ composite fine particle having solid-dissolved therein barium and strontium. FIG. 1 shows the X-ray diffraction spectrum of the powder particle.

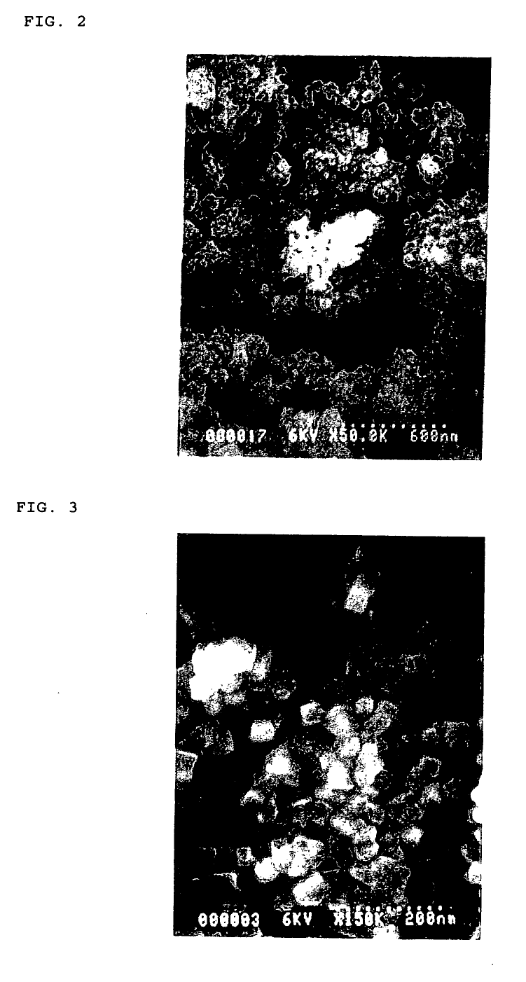

The specific surface area of the particle was measured by the BET method and found to be 49 m²/g. The shape was observed by enlarging it through a scanning electron microscope and found to be spherical. (see FIG. 2.)

The average primary particle size D1 calculated according to formula (1) was 0.022 μm. Also, the average particle size D2 determined by dispersing the powder particles in pure water and measuring the particle size by a light-scattering particle size distribution measuring device (ELS-8000) manufactured by Otsuka Electronics Co., Ltd. was 0.17 μm. Thus, D2/D1 was 7.7.

About 6 mg of this dry powder particle and about 900 mg of KBr were ground and mixed and about 800 mg of the obtained mixture was pressed into a tablet shape. Also, standard barium carbonate was similarly pressed into a tablet shape. Then, the infrared absorption spectrum was measured by FTS6000 manufactured by Bio-Rad. The peak intensities of standard barium carbonate and strontium carbonate in the vicinity of 880 cm⁻¹ were compared with the peak intensity of barium.strontium titanate of the present invention. The total amount of barium carbonate and strontium carbonate contained in this powder particle was 0.5 mass %.

The dry powder was dissolved and the potassium (K) ion amount was measured by the ICP emission method, as a result, 20 ppm of K ion was contained. Also, the chlorine (Cl) ion amount was measured by anion chromatography, as a result, 100 ppm of Cl ion was contained.

In a nitrogen glove box, 1.5 g of the dry powder and a stirring bar were charged into 45 ml of ion exchanged water and after tightly stoppering, thoroughly stirred using a stirrer for 24 hours or more. Thereafter, the supernatant was separated and filtered through a membrane filter. Then, 0.5 ml of concentrated nitric acid and water in an amount to make 25 ml were added to 1 ml of the filtrate. The amounts of barium ion and strontium ion were determined by the ICP emission method. The extracted amount calculated according to formula (3) was 0.22 mmol/m².

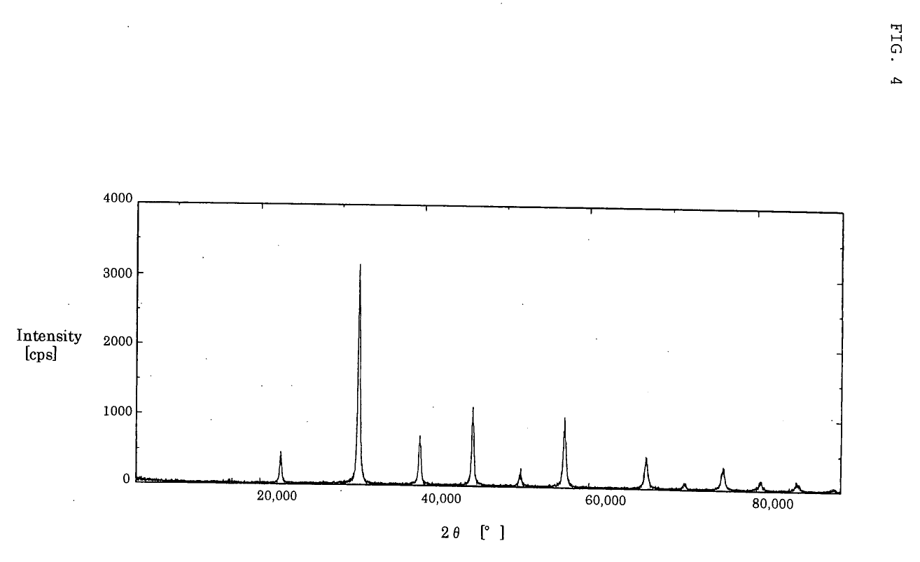

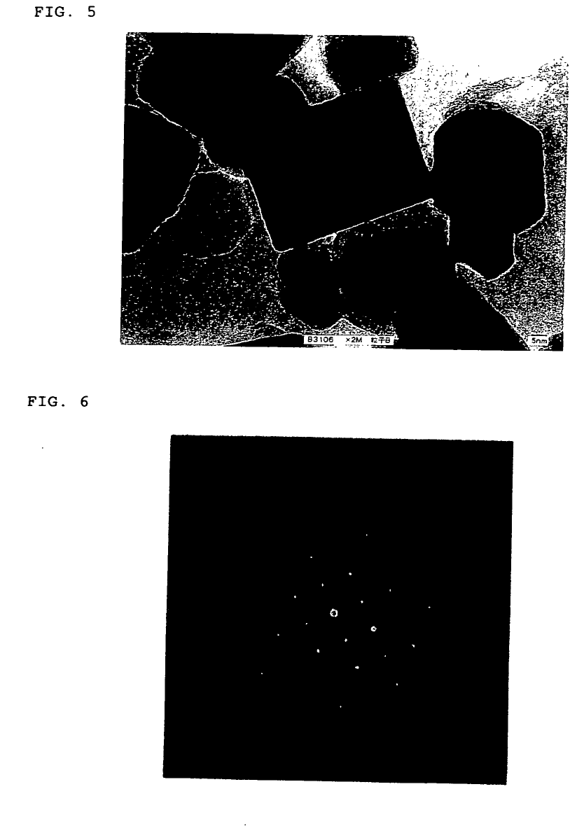

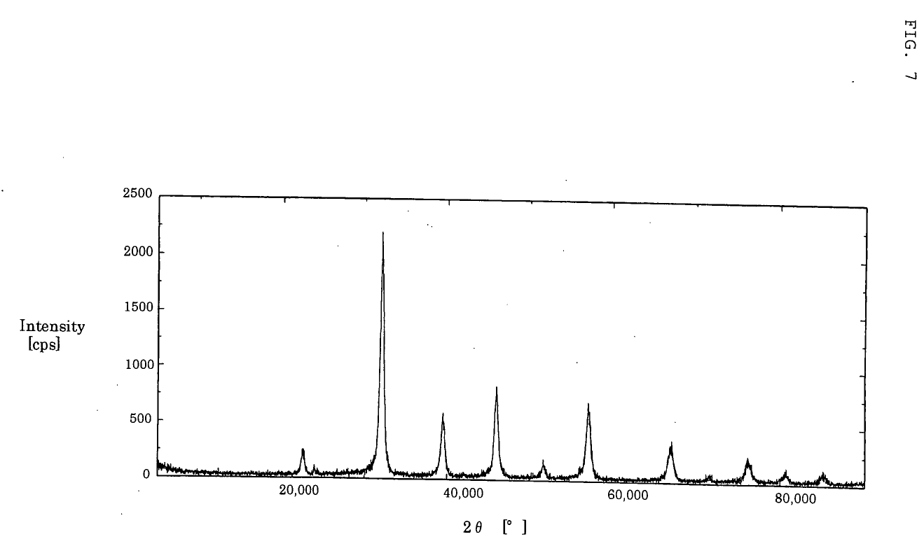

The dry powder was placed in an electric furnace (KDFP-90) manufactured by Denken Co., Ltd. and after elevating the temperature at a rate of 20° C. per minute and keeping at 950° C. for 2 hours, naturally cooled. The specific surface area of the obtained powder was 21 m²/g and the percentage decrease in the specific surface area, calculated according to formula (2), was 57%. The shape confirmed by enlarged observation through a scanning electron microscope was a dice form (see FIG. 3). FIG. 4 shows the X-ray diffraction spectrum of the powder particle. Also, the obtained sample was observed through a transmission electron microscope (H-9000 UHR: manufactured by Hitachi, Ltd.) (see FIG. 5) and found to be a single crystal by electron diffraction image (see FIG. 6).

### EXAMPLE 2

A barium.strontium titanate composite fine particle was produced by the same operation as in Example 1 except for using 50.5 g of barium hydroxide octahydrate and 63.8 g of strontium hydroxide octahydrate.

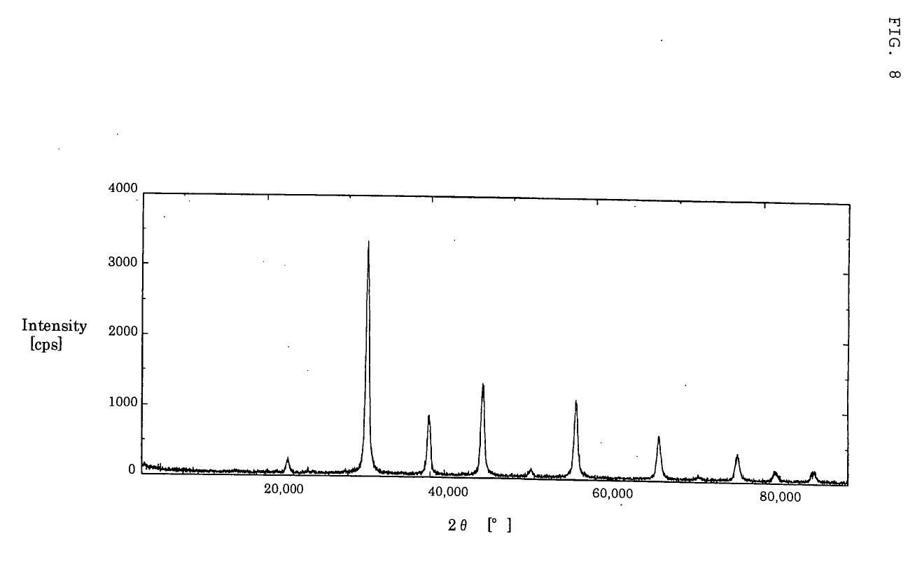

The reaction was continued until the total concentration of barium ion and strontium ion in the reaction solution became 1/1,000 or less of the amount charged. The ratio of the actual yield to the theoretical yield was 99.9%, the specific surface area was 48 m²/g, the particle was a perovskite Ba_{0.4}Sr_{0.6}TiO₃ composite having solid-dissolved therein barium and strontium, and the shape was spherical. FIG. 7 shows the X-ray diffraction spectrum of the powder particle.

D1 was 0.023 μm, D2 was 0.17 μm, and D2/D1 was 7.4. The total amount of barium carbonate and strontium carbonate contained in this powder particle was 0.4 mass %.

The dry powder was dissolved and the K ion amount was measured by the ICP emission method, as a result, 10 ppm of K ion was contained. Also, the Cl ion amount was measured by anion chromatography, as a result, 80 ppm of Cl ion was contained.

The total extracted amount of barium ion and strontium ion, calculated according to formula (3), was 0.32 μmol/m². After keeping at 950° C. for 2 hours, the specific surface area was 23 m²/g, the percentage decrease in the specific surface area, calculated according to formula (2), was 52%, the shape was a dice form, and the particle was a single crystal.

### EXAMPLE 3

A strontium titanate fine particle was produced by the same operation as in Example 1 except for using 0 g of barium hydroxide octahydrate and 106.3 g of strontium hydroxide octahydrate.

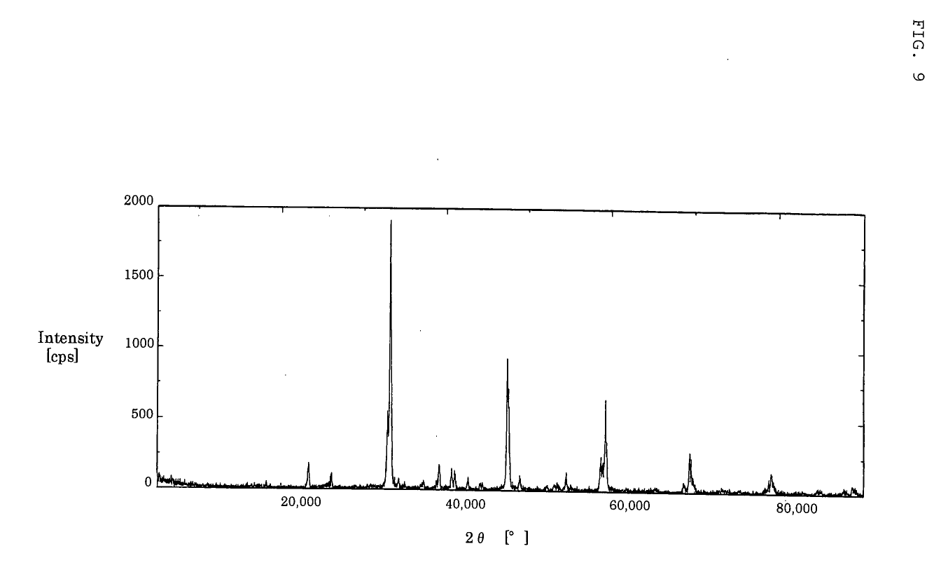

The reaction was continued until the concentration of strontium ion in the reaction solution became 1/1,000 or less of the amount charged. The ratio of the actual yield to the theoretical yield was 99.9%, the specific surface area was 46 m²/g, the particle was a perovskite SrTiO₃, and the shape was spherical. FIG. 8 shows the X-ray diffraction spectrum of the powder particle.

D1 was 0.025 μm, D2 was 0.16 μm, and D2/D1 was 6.4. The amount of strontium carbonate contained in this powder particle was 0.6 mass %.

The dry powder was dissolved and the K ion amount was measured by the ICP emission method, as a result, 25 ppm of K ion was contained. Also, the Cl ion amount was measured by anion chromatography, as a result, 92 ppm of Cl ion was contained.

The extracted amount of ion, calculated according to formula (3), was 0.36 μmol/m². After keeping at 950° C. for 2 hours, the specific surface area was 15 m²/g, the percentage decrease in the specific surface area, calculated according to formula (2), was 67%, the shape was a dice form, and the particle was a single crystal.

### EXAMPLE 4

A barium titanate fine particle was produced by the same operation as in Example 1 except for using 126.2 g of barium hydroxide octahydrate and 0 g of strontium hydroxide octahydrate.

The reaction was continued until the total concentration of barium ion in the reaction solution became 1/1,000 or less of the amount charged. The ratio of the actual yield to the theoretical yield was 99.9%, the specific surface area was 39 m²/g, the particle was perovskite BaTiO₃, and the shape was spherical.

D1 was 0.024 μm, D2 was 0.16 μm, and D2/D1 was 6.4. The amount of barium carbonate contained in this powder particle was 0.5 mass %.

The dry powder was dissolved and the K ion amount was measured by the ICP emission method, as a result, 18 ppm of K ion was contained. Also, the Cl ion amount was measured by anion chromatography, as a result, 100 ppm of Cl ion was contained.

The extracted amount of ion, calculated according to formula (3), was 0.36 μmol/m².

After keeping at 950° C. for 2 hours, the specific surface area was 4 m²/g, the percentage decrease in the specific surface area, calculated according to formula (2), was 90%, the shape was spherical, and the particle was a single crystal.

### EXAMPLE 5

A barium.strontium titanate composite fine particle was produced by the same operation as in Example 1 except for using 1.3 g of barium hydroxide octahydrate and 105.2 g of strontium hydroxide octahydrate.

The reaction was continued until the total concentration of barium ion and strontium ion in the solution after reaction became 1/1,000 or less of the amount charged. The ratio of the actual yield to the theoretical yield was 99.9%, the specific surface area was 46 m²/g, the particle was a perovskite Ba_{0.01}Sr_{0.99}TiO₃ composite having solid-dissolved therein barium and strontium, and the shape was spherical.

D1 was 0.025 μm, D2 was 0.16 μm, and D2/D1 was 6.4. The total amount of barium carbonate and strontium carbonate contained in this powder particle was 0.6 mass %.

The dry powder was dissolved and the K ion amount was measured by the ICP emission method, as a result, 16 ppm of K ion was contained. Also, the Cl ion amount was measured by anion chromatography, as a result, 80 ppm of Cl ion was contained.

The extracted amount of ion, calculated according to formula (3), was 0.36 μmol/m².

After keeping at 950° C. for 2 hours, the specific surface area was 16 m²/g, the percentage decrease in the specific surface area was 65%, the shape was a dice form, and the particle was a single crystal.

### EXAMPLE 6

A barium.strontium titanate composite fine particle was produced by the same operation as in Example 1 except for using 124.9 g of barium hydroxide octahydrate and 1.1 g of strontium hydroxide octahydrate.

The reaction was continued until the total concentration of barium ion and strontium ion in the reaction solution became 1/1,000 or less of the amount charged. The ratio of the actual yield to the theoretical yield was 99.9%, the specific surface area was 43 m²/g, the particle was perovskite Ba_{0.99}Sr_{0.01}TiO₃, and the shape was spherical.

D1 was 0.024 μm, D2 was 0.17 μm, and D2/D1 was 7.1. The total amount of barium carbonate and strontium carbonate contained in this powder particle was 0.4 mass %.

The dry powder was dissolved and the K ion amount was measured by the ICP emission method, as a result, 21 ppm of K ion was contained. Also, the Cl ion amount was measured by anion chromatography, as a result, 95 ppm of Cl ion was contained.

The total extracted amount of ions, calculated according to formula (3), was 0.42 mmol/m².

After keeping at 950° C. for 2 hours, the specific surface area was 5 m²/g, the percentage decrease in the specific surface area was 88%, the shape was spherical, and the particle was a single crystal.

### EXAMPLE 7

A barium.strontium titanate composite fine particle was produced by the same operation as in Example 1 except for using a commercially available anatase titanium oxide sol (STS-02, produced by Ishihara Sangyo Kaisha Ltd.) in place of the brookite titanium oxide sol synthesized in Example 1.

The reaction was continued until the total concentration of barium ion and strontium ion in the reaction solution became 1/1,000 or less of the amount charged. The ratio of the actual yield to the theoretical yield was 99.9%, the specific surface area was 57 m²/g, the particle was a perovskite Ba_{0.6}Sr_{0.4}TiO₃ composite having solid-dissolved therein barium and strontium, and the shape was spherical.

D1 was 0.018 μm, D2 was 0.17 μm, and D2/D1 was 9.4. The total amount of barium carbonate and strontium carbonate contained in this powder particle was 0.5 mass %.

The dry powder was dissolved and the K ion amount was measured by the ICP emission method, as a result, 20 ppm of K ion was contained. Also, the Cl ion amount was measured by anion chromatography, as a result, 60 ppm of Cl ion was contained.

The total extracted amount of ions, calculated according to formula (3), was 0.53 μmol/m².

After keeping at 950° C. for 2 hours, the specific surface area was 30 m²/g, the percentage decrease in the specific surface area was 47%, the shape was a dice form, and the particle was a single crystal.

### COMPARATIVE EXAMPLE 1

A barium.strontium titanate composite fine particle was produced by the same operation as in Example 1 except for using 58.6 g of barium chloride dihydrate in place of barium hydroxide octahydrate and 42.7 g of strontium chloride hexahydrate in place of strontium hydroxide octahydrate.

The reaction was continued until the total concentration of barium ion and strontium ion in the reaction solution became 1/1,000 or less of the amount charged. The ratio of the actual yield to the theoretical yield was 99.9%, the specific surface area was 48 m²/g, the particle was a perovskite Ba_{0.6}Sr_{0.4}TiO₃ composite having solid-dissolved therein barium and strontium, and the shape was spherical.

D1 was 0.022 μm, D2 was 0.17 μm, and D2/D1 was 7.7. The total amount of barium carbonate and strontium carbonate contained in this powder particle was 0.5 mass %. The total extracted amount of ions, calculated according to formula (3), was 0.46 mmol/m².

After keeping at 950° C. for 2 hours, the specific surface area was 25 m²/g, the percentage decrease in the specific surface area was 48%, the shape was a dice form, and the particle was a single crystal.

However, when the dry powder was dissolved and the Cl ion was measured by anion chromatography, 14,000 ppm of Cl ion was contained per g of the powder and the barium.strontium composite fine particle produced by this method was not suitable for an electronic material.

### COMPARATIVE EXAMPLE 2

In Comparative Example 1, water washing and filtration were repeated 10 times after the synthesis. The Cl ion amount was decreased to 500 μg per g of the dry powder. The amount of barium in the filtrate at the 10th filtration was 20 ppm and the amount of strontium was 15 ppm. The dry powder was dissolved and measured, as a result, the ratio of titanium to the total of barium and strontium was 0.94.

### COMPARATIVE EXAMPLE 3

A barium.strontium titanate composite fine particle was produced by the same operation as in Example 1 except for using 20% KOH in place of TMAH.

The reaction was continued until the total concentration of barium ion and strontium ion in the reaction solution became 1/1,000 or less of the amount charged. The ratio of the actual yield to the theoretical yield was 99.9% and the specific surface area was 48 m²/g. The particle was evaluated by X-ray diffraction and found to be a perovskite Ba_{0.6}Sr_{0.4}TiO₃ composite having solid-dissolved therein barium and strontium. Also, the shape was observed by enlarging it through an electron microscope and found to be spherical.

D1 was 0.022 μm, D2 was 0.16 μm, and D2/D1 was 7.3. The total amount of barium carbonate and strontium carbonate contained in this powder particle was 0.5 mass %. The total extracted amount of ions, calculated according to formula (3), was 0.46 μmol/m².

After keeping at 950° C. for 2 hours, the specific surface area was 25 m²/g, the percentage decrease in the specific surface area was 48%, the shape was a dice form, and the particle was a single crystal.

However, when the dry powder was dissolved and the K ion was measured by the ICP emission method, 5,000 ppm of K ion was contained per g of the powder and the barium.strontium composite fine particle produced by this method was not suitable for an electronic material.

### COMPARATIVE EXAMPLE 4

In Comparative Example 3, water washing and filtration were repeated 10 times after the synthesis. The K ion amount was decreased to 300 ppm per g of the dry powder. The amount of barium in the filtrate at the 10th filtration was 18 ppm and the amount of strontium was 12 ppm. The dry powder was dissolved and measured, as a result, the ratio of titanium to the total of barium ion and strontium ion was 0.96.

### COMPARATIVE EXAMPLE 5

A barium.strontium titanate composite fine particle was produced by the same operation as in Example 1 except for using 368 g of pure water instead of adding TMAH.

The reaction was continued until the total concentration of barium ion and strontium ion in the reaction solution became 2% of the amount charged. The ratio of the actual yield to the theoretical yield was 98%. The water in the filtrate was evaporated and by drying the filtrate at 300° C. for 5 hours, powder particles were obtained. The powder particles were examined by X-ray diffraction and found to contain barium hydroxide and strontium hydroxide which were raw materials. The total extracted amount of ions, calculated according to formula (3), was 30 μmol/m².

### COMPARATIVE EXAMPLE 6

A barium.strontium titanate composite fine particle was produced by the same operation as in Comparative Example 5 except for continuing the boiling with stirring for 12 hours in place of 4 hours.

The reaction was continued until the total concentration of barium ion and strontium ion in the reaction solution became 1.7% of the amount charged. The ratio of the actual yield to the theoretical yield was 98.3%. The water in the filtrate was evaporated and by drying the filtrate at 300° C. for 5 hours, powder particles were obtained. The powder particles were examined by X-ray diffraction and found to contain barium hydroxide and strontium hydroxide which were raw materials. The total extracted amount of barium ion and strontium ion, calculated according to formula (3), was 26 μmol/m².

### COMPARATIVE EXAMPLE 7

A barium.strontium titanate composite fine particle was produced by the same operation as in Example 1 except for continuing the boiling with stirring for 1 hour in place of 4 hours.

The reaction was continued until the total concentration of barium ion and strontium ion in the reaction solution became 0.4% of the amount charged. The ratio of the actual yield to the theoretical yield was 99.6%. The water in the filtrate was evaporated and by drying the filtrate at 300° C. for 5 hours, powder particles were obtained. The powder particles were examined by X-ray diffraction and found to contain barium hydroxide and strontium hydroxide which were raw materials. The total extracted amount of ions, calculated according to formula (3), was 5 mmol/m².

### COMPARATIVE EXAMPLE 8

A barium.strontium titanate was produced by the same operation as in Example 1 except that the aqueous 20 mass % tetramethylammonium hydroxide solution (produced by Sachem Showa K.K., concentration of carbonic acid root: 60 ppm or less) was left standing in air and thereby the concentration of carbonic acid group was increased to 6,000 ppm.

The reaction was continued until the total concentration of barium ion and strontium ion in the reaction solution became 1/1,000 or less of the amount charged. The ratio of the actual yield to the theoretical yield was 99.9 mass %. The obtained powder particle was examined in the same manner as in Example 1, as a result, the total amount of barium carbonate and strontium carbonate contained in the powder particle was 6 mass %. The total extracted amount of ions, calculated according to formula (3), was 7 mmol/m².

### EXAMPLE 8

An aqueous solution having a titanium tetrachloride (produced by Sumitomo Titanium Corporation, purity: 99.9%) concentration of 0.25 mol/L was charged into a reactor with a reflux condenser and heated to the vicinity of boiling point while keeping the solution acidic by preventing chloride ion from escaping. The solution was kept at that temperature for 60 minutes and thereby the titanium tetrachloride was hydrolyzed to obtain a titanium oxide sol. The obtained titanium oxide sol was dried at 110° C. and the crystal type was examined by an X-ray diffraction device (RAD-B Rotor Flex) manufactured by Rigaku Corporation and found to be a brookite titanium oxide.

To 29.6 g of calcium hydroxide (produced by Wako Pure Chemical Industries, Ltd., purity: 99.9%) and 213 g of a sol having a titanium oxide concentration of 15 mass % obtained by precipitating and concentrating the sol prepared above from which chlorine was removed by an electrodialyser to 500 ppm, 456 g of an aqueous 20 mass % tetramethylammonium hydroxide solution (produced by Sachem Showa K.K., concentration of carbonic acid group: 60 ppm or less) was added. In a reactor with a reflux condenser, the resulting solution was heated with stirring to boil while passing a small amount of nitrogen. The boiling was continued for 6 hours with stirring. Subsequently, the heating was stopped while continuing the stirring and the resulting solution was air-cooled to 50° C. or less and then filtered in a vacuum. The obtained cake was dried at 300° C. for 5 hours to obtain a dry powder. The ratio of the actual yield to the theoretical yield calculated from the amounts of titanium oxide and calcium hydroxide used in the reaction was 99.9 mass %.

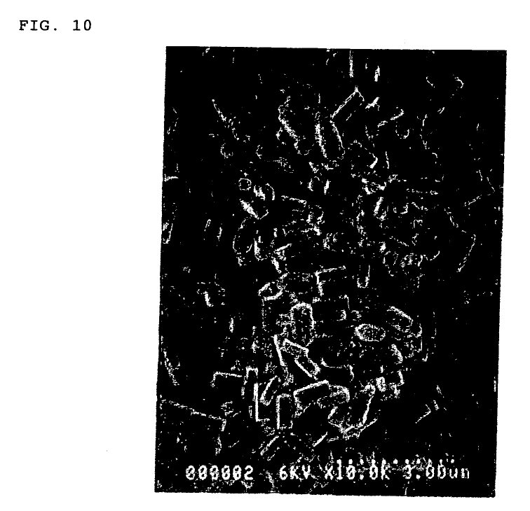

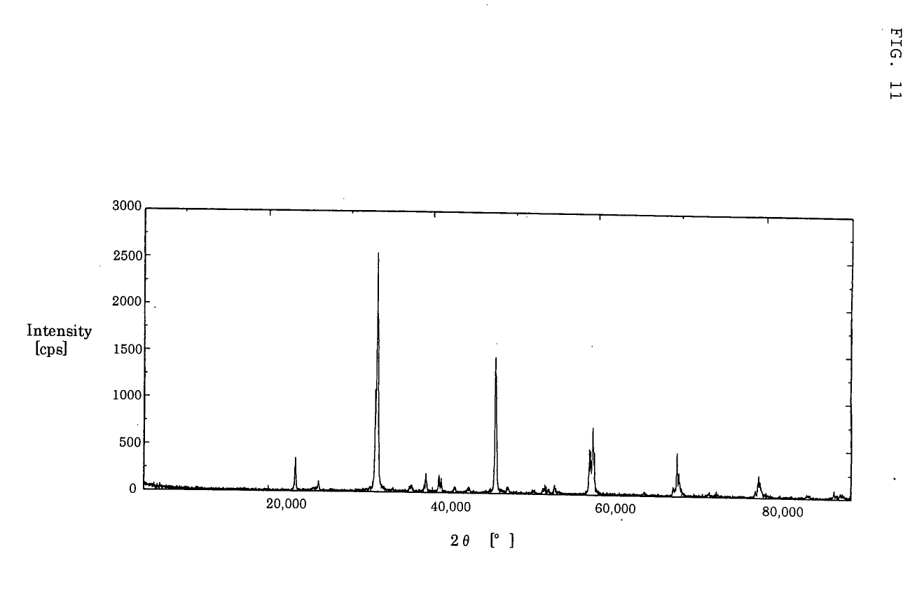

The X-ray diffraction of this powder particle was examined by an X-ray diffraction device (RAD-B Rotor Flex) manufactured by Rigaku Corporation, as a result, the obtained powder particle was perovskite calcium titanate. FIG. 9 shows the X-ray diffraction spectrum at this time. The specific surface area of the obtained particle was determined by the BET method and found to be 4.7 m²/g. Also, the shape of the obtained powder particle was observed through a scanning electron microscope and found to be a shape analogous to tetragonal prism as shown in FIG. 2.

The obtained calcium titanate particle was observed through a transmission electron microscope and found to be a single crystal. Furthermore, the electron beam photograph was analyzed, as a result, the long side of the tetragonal prism-like particle was extending to the (010) direction.

The average primary particle size D1 calculated according to formula (1) was 0.32 μm. The powder particles were dispersed in water having dissolved therein 0.03% of Poise 532A (produced by Kao Corp.) as a dispersant and the secondary particle size distribution of this powder particle was measured by using Shimadzu Centrifugal Precipitation-Type Particle Size Distribution Measuring Device (Model SA-CP4L) and setting the conditions such that the particle size distribution on the weight basis could be measured in the range from the maximum of 30 μm to the minimum of 0.03 μm.

The average particle size D2 was 0.71 μm, the particle size D3 at the distribution of 10% from the minimum particle size was 0.34 μm, and the particle size D4 at 90% from the minimum particle size was 1.10 μm. From these, D2/D1 was 2.2, D3/D2 was 0.48 and D4/D2 was 1.55.

This powder particle (about 6 mg) and about 900 mg of KBr were ground and mixed and about 800 mg of the obtained mixture was pressed into a tablet shape. Also, standard calcium carbonate (produced by Wako Pure Chemical Industries, Ltd., purity: 99.99%) was similarly pressed into a tablet shape. Then, the infrared absorption spectrum was measured by FTS6000 manufactured by Bio-Rad. The peak intensity of standard calcium carbonate in the vicinity of 880 cm⁻¹ were compared with the peak area intensity of calcium titanate of the present invention. The amount of calcium carbonate contained in this powder particle was 0.5 mass %.

### EXAMPLE 9

A perovskite calcium titanate powder particle was obtained in the same manner as in Example 8. This powder particle was kept at 950° C. for 2 hours and thereby baked.

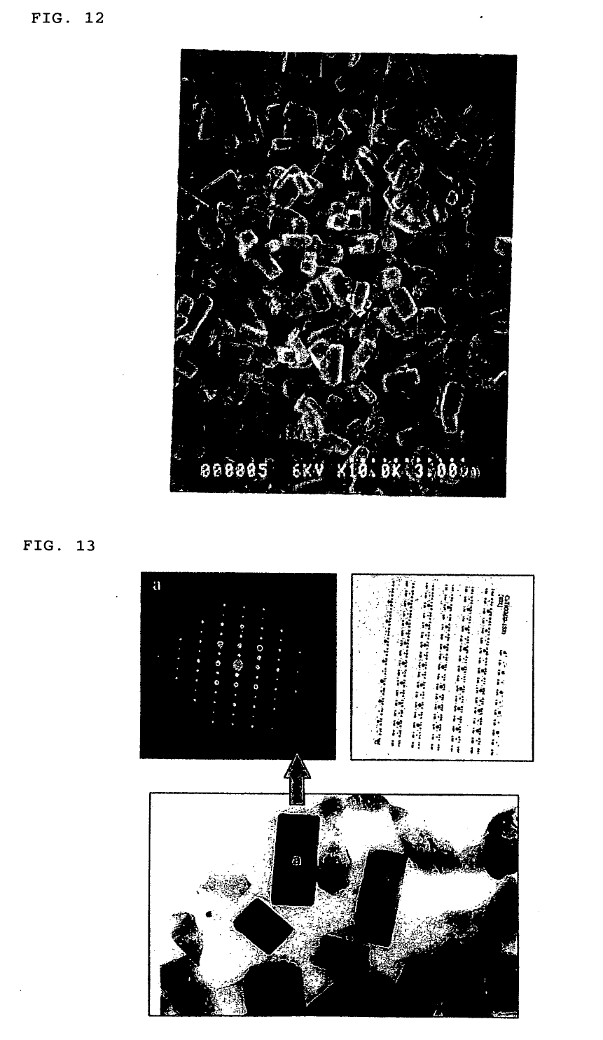

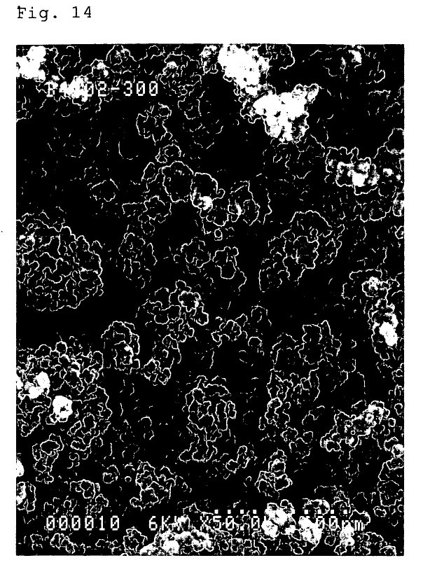

The obtained powder particle was examined in the same manner as in Example 8 and found to be a perovskite calcium titanate having a specific surface area of 3.6 m²/g. FIG. 11 shows the X-ray diffraction spectrum. The decrease in the specific surface area by the calcining was 1.1 m²/g. The shape of the calcium titanate powder was observed by a scanning electron microscope and found to be a shape analogous to tetragonal prism as shown in FIG. 12. Also, Analysis was conducted by limited area electron diffraction using a transmission electron microscope (H-9000UHR: manufactured by Hitachi, Ltd.) under acceleration voltage of 300 kV. The results are shown in FIG. 13. The obtained sample was found to be a single crystal where the long side of the tetragonal prism-like particle was along the (010) direction while the short side along the (101) direction.

The particle size distribution was measured in the same manner as in Example 8, as a result, D1 was 0.42 μm, D2 was 1.12 μm, D3 was 0.28 μm and D4 was 5.56 μm. From these, D2/D1 was 2.7, D3/D2 was 0.25 and D4/D2 was 4.96.

### EXAMPLE 10

A calcium titanate was synthesized by the same operation as in Example 8 except that 45.6 g of the aqueous 20 mass % tetramethylammonium hydroxide solution (produced by Sachem Showa K.K.) was diluted by adding thereto 410.4 g of pure water. The ratio of the actual yield to the theoretical yield was 99.7 mass %.

The obtained powder particle was examined in the same manner as in Example 8 and found to be a perovskite calcium titanate having a specific surface area of 5.7 m²/g. The shape was a shape analogous to tetragonal prism. Also, this powder was found to be a single crystal where the long side of the tetragonal prism-like particle was extending to the (010) direction.

The particle size distribution was measured in the same manner as in Example 8, as a result, D1 was 0.26 μm, D2 was 0.72 μm, D3 was 0.30 μm and D4 was 1.75 μm. From these, D2/D1 was 2.8, D3/D2 was 0.42 and D4/D2 was 2.43.

### EXAMPLE 11

A calcium titanate was synthesized by the same operation as in Example 8 except for using a commercially available anatase titanium oxide sol (ST-02, produced by Ishihara Sangyo Kaisha Ltd.) in place of the brookite titanium oxide sol synthesized in Example 8. The ratio of the actual yield to the theoretical yield was 99.9 mass %.

The obtained powder particle was examined in the same manner as in Example 8 and found to be a perovskite calcium titanate having a specific surface area of 3.9 m²/g. The shape was a shape analogous to tetragonal prism. Also, this powder was found to be a single crystal where the long side of the tetragonal prism-like particle was extending to the (010) direction.

The particle size distribution was measured in the same manner as in Example 8, as a result, D1 was 0.38 μm, D2 was 0.69 μm, D3 was 0.17 μm and D4 was 1.08 μm. From these, D2/D1 was 1.8, D3/D2 was 0.25 and D4/D2 was 1.57.

### EXAMPLE 12

A calcium titanate was synthesized by the same operation as in Example 8 except for using 0.296 g of calcium hydroxide. The ratio of the actual yield to the theoretical yield was 99.9 mass %. The obtained powder particle was examined in the same manner as in Example 8 and found to be a perovskite calcium titanate

The obtained powder particle was examined in the same manner as in Example 8 and found to be a perovskite calcium titanate having a specific surface area of 4.8 m²/g. The shape was a shape analogous to tetragonal prism. Also, this powder was found to be a single crystal where the long side of the tetragonal prism-like particle was extending to the (010) direction.

The particle size distribution was measured in the same manner as in Example 8, as a result, D1 was 0.31 μm, D2 was 0.65 μm, D3 was 0.23 μm and D4 was 1.21 μm. From these, D2/D1 was 2.1, D3/D2 was 0.35 and D4/D2 was 1.86.

### EXAMPLE 13

A calcium titanate was synthesized by the same operation as in Example 8 except for using 58.8 g of calcium chloride dihydrate (produced by Wako Pure Chemical Industries, Ltd., purity: 99.9%) in place of calcium hydroxide. After vacuum filtration, the cake obtained was repeatedly washed with water and filtered to have a Cl concentration of 100 ppm. Thereafter, the cake obtained by vacuum filtration was dried at 300° C. for 5 hours to obtain a dry powder. The ratio of the actual yield to the theoretical yield calculated from the amounts of titanium oxide and calcium hydroxide used in the reaction was 99.9 mass %.

The obtained powder particle was examined in the same manner as in Example 8 and found to be a perovskite calcium titanate having a specific surface area of 4.6 m²/g. The shape was a shape analogous to tetragonal prism. Also, this powder was found to be a single crystal where the long side of the tetragonal prism-like particle was extending to the (010) direction.

The particle size distribution was measured in the same manner as in Example 8, as a result, D1 was 0.33 μm, D2 was 0.75 μm, D3 was 0.22 μm and D4 was 1.36 μm. From these, D2/D1 was 2.3, D3/D2 was 0.29 and D4/D2 was 1.81.

### EXAMPLE 14

A calcium titanate was synthesized by the same operation as in Example 8 except for using KOH (produced by Wako Pure Chemical Industries, Ltd., highest quality) in place of TMAH. After vacuum filtration, the cake obtained was repeatedly washed with water and filtered to have a K concentration of 100 ppm. Thereafter, the cake obtained by vacuum filtration was dried at 300° C. for 5 hours to obtain a dry powder. The ratio of the actual yield to the theoretical yield calculated from the amounts of titanium oxide and calcium hydroxide used in the reaction was 99.3 mass %.

The obtained powder particle was examined in the same manner as in Example 8 and found to be a perovskite calcium titanate having a specific surface area of 4.4 m²/g. The shape was a shape analogous to tetragonal prism. Also, this powder was found to be a single crystal where the long side of the tetragonal prism-like particle was extending to the (010) direction.

The particle size distribution was measured in the same manner as in Example 8, as a result, D1 was 0.34 μm, D2 was 0.74 μm, D3 was 0.23 μm and D4 was 1.30 μm. From these, D2/D1 was 2.2, D3/D2 was 0.31 and D4/D2 was 1.76.

### COMPARATIVE EXAMPLE 9

A calcium titanate was synthesized by the same operation as in Example 8 except that the aqueous 20 mass % tetramethylammonium hydroxide solution (produced by Sachem Showa K.K., concentration of carbonic acid root: 60 ppm or less) was left standing in air and thereby the concentration of carbonic acid group was increased to 6,000 ppm. The ratio of the actual yield to the theoretical yield was 99.9 mass %.

The obtained powder particle was examined in the same manner as in Example 8, as a result, it was found that 6 mass % of calcium carbonate was mixed. The BET specific surface area was 7.2 m²/g.

The particle size distribution was measured in the same manner as in Example 8, as a result, D1 was 0.20 μm, D2 was 0.80 μm, D3 was 0.20 μm and D4 was 2.10 μm. From these, D2/D1 was 4.0, D3/D2 was 0.25 and D4/D2 was 2.63.

### COMPARATIVE EXAMPLE 10

A calcium titanate was synthesized by the same operation as in Example 8 except for using 0.0185 g of calcium hydroxide. The ratio of the actual yield to the theoretical yield was 99.9 mass %.

The obtained powder particle was examined in the same manner as in Example 8 and found to be a perovskite calcium titanate. The specific surface area of the obtained particle was 23 m²/g and the majority was a spherical fine particle.

The particle size distribution was measured in the same manner as in Example 8, as a result, D1 was 0.065 μm, D2 was 0.6 μm, D3 was 0.04 μm and D4 was 11.0 μm. From these, D2/D1 was 9.2, D3/D2 was 0.06 and D4/D2 was 18.3.

### COMPARATIVE EXAMPLE 11

A calcium titanate was synthesized by the same operation as in Example 8 except for using 368 g of pure water instead of adding TMAH. The pH at this time was 7.1. The ratio of the actual yield to the theoretical yield was 99.6 mass %. The obtained powder particle was examined in the same manner as in Example 8 and found to be a perovskite calcium titanate where a large amount of calcium hydroxide and titanium oxide remained as raw materials remained unreacted.

### COMPARATIVE EXAMPLE 12

A calcium titanate was synthesized by the same operation as in Example 8 except that 73 g of ethylene-diaminetetraacetic acid was added and calcium hydroxide was dissolved and reacted. The obtained dry powder particle was kept at 900° C. for 2 hours, thereby decomposing the ethylenediaminetetraacetic acid. The obtained powder particle was examined in the same manner as in Example 8, as a result, it was found that almost no perovskite calcium titanate was obtained.

### COMPARATIVE EXAMPLE 13

A calcium titanate was synthesized by the same operation as in Example 8 except for changing the reaction time to 1 hour. The ratio of the actual yield to the theoretical yield was 99.5 mass %. The BET specific surface area of the obtained powder particle was 27.1 m²/g. In the X-ray diffraction spectrum, the peaks of titanium oxide and calcium hydroxide as raw materials were very slightly observed but the majority was a perovskite calcium titanate.

The shape of the particle was observed through a scanning electron microscope, as a result, the majority was a spherical fine particle and the number of tetragonal prism-like fine particles was very small.

The particle size distribution was measured in the same manner as in Example 8, as a result, D1 was 0.06 μm, D2 was 0.64 μm, D3 was 0.05 μm and D4 was 11.5 μm. From these, D2/D1 was 10.6, D3/D2 was 0.08 and D4/D2 was 18.0.

### EXAMPLE 15

A barium.strontium titanate composite fine particle was produced by the same operation as in Example 1 except for using 77.2 g of barium hydroxide octahydrate and 43.5 g of strontium hydroxide octahydrate.

The reaction was continued until the total concentration of barium ion and strontium ion in the reaction solution became 1/1,000 or less of the amount charged. The ratio of the actual yield to the theoretical yield was 99.9%, the specific surface area was 46 m²/g, the particle was a perovskite Ba_{0.6}Sr_{0.4}TiO₃ composite having solid-dissolved therein barium and strontium, and the shape was spherical.

D1 was 0.023 μm, D2 was 0.17 μm, and D2/D1 was 7.4. The total amount of barium carbonate and strontium carbonate contained in this powder particle was 0.5 mass %.

The dry powder was dissolved and the K ion amount was measured by the ICP emission method, as a result, 10 ppm of K ion was contained. Also, the Cl ion amount was measured by anion chromatography, as a result, 100 ppm of Cl ion was contained.

The total extracted amount of barium ion and strontium ion, calculated according to formula (3), was 0.60 μmol/m². After keeping at 950° C. for 2 hours, the specific surface area was 24 m²/g, the percentage decrease in the specific surface area, calculated according to formula (2), was 48%, the shape was a dice form, and the particle was a single crystal.

### EXAMPLE 16

A barium.strontium titanate composite fine particle was produced by the same operation as in Example 1 except for using 74.2 g of barium hydroxide octahydrate and 41.7 g of strontium hydroxide octahydrate.

The reaction was continued until the total concentration of barium ion and strontium ion in the reaction solution became 1/1,000 or less of the amount charged. The ratio of the actual yield to the theoretical yield was 99.9%, the specific surface area was 49 m²/g, the particle was a perovskite Ba_{0.6}Sr_{0.4}TiO₃ composite having solid-dissolved therein barium and strontium, and the shape was spherical.

D1 was 0.022 μm, D2 was 0.18 μm, and D2/D1 was 8.2. The total amount of barium carbonate and strontium carbonate contained in this powder particle was 0.4 mass %.

The dry powder was dissolved and the K ion amount was measured by the ICP emission method, as a result, 20 ppm of K ion was contained. Also, the Cl ion amount was measured by anion chromatography, as a result, 110 ppm of Cl ion was contained.

The total extracted amount of barium ion and strontium ion, calculated according to formula (3), was 0.70 μmol/m². After keeping at 950° C. for 2 hours, the specific surface area was 21 m²/g, the percentage decrease in the specific surface area, calculated according to formula (2), was 57%, the shape was a dice form, and the particle was a single crystal.

### COMPARATIVE EXAMPLE 14

A barium.strontium titanate composite fine particle was produced by the same operation as in Example 1 except for using 79.5 g of barium hydroxide octahydrate and 44.6 g of strontium hydroxide octahydrate.

The reaction was continued until the total concentration of barium ion and strontium ion in the reaction solution became 1/1,000 or less of the amount charged. The ratio of the actual yield to the theoretical yield was 99.9%, the specific surface area was 46 m²/g, the particle was a perovskite Ba_{0.6}Sr_{0.4}TiO₃ composite having solid-dissolved therein barium and strontium, though only a few of X-ray diffraction peaks could not be unidentified, and the shape was spherical.

D1 was 0.023 μm, D2 was 0.20 μm, and D2/D1 was 8.7. The total amount of barium carbonate and strontium carbonate contained in this powder particle was 0.5 mass %.

The dry powder was dissolved and the K ion amount was measured by the ICP emission method, as a result, 20 ppm of K ion was contained. Also, the Cl ion amount was measured by anion chromatography, as a result, 120 ppm of Cl ion was contained.

The total extracted amount of barium ion and strontium ion, calculated according to formula (3), was 3.3 mmol/m².

### COMPARATIVE EXAMPLE 15

A barium.strontium titanate composite fine particle was produced by the same operation as in Example 1 except for using 71.9 g of barium hydroxide octahydrate and 40.4 g of strontium hydroxide octahydrate.

The reaction was continued until the total concentration of barium ion and strontium ion in the reaction solution became 1/1,000 or less of the amount charged. The ratio of the actual yield to the theoretical yield was 99.9%, the specific surface area was 51 m²/g, the particle was a perovskite Ba_{0.6}Sr_{0.4}TiO₃ composite having solid-dissolved therein barium and strontium, and the shape was spherical.

D1 was 0.021 μm, D2 was 0.19 μm, and D2/D1 was 9.0. The total amount of barium carbonate and strontium carbonate contained in this powder particle was 0.4 mass %.

The dry powder was dissolved and the K ion amount was measured by the ICP emission method, as a result, 30 ppm of K ion was contained. Also, the Cl ion amount was measured by anion chromatography, as a result, 100 ppm of Cl ion was contained.

The total extracted amount of barium ion and strontium ion, calculated according to formula (3), was 3.9 μmol/m².

### EXAMPLE 17

A barium.calcium titanate composite fine particle was produced by the same operation as in Example 1 except for using 119.9 g of barium hydroxide octahydrate and using 1.5 g of calcium hydroxide instead of strontium hydroxide octahydrate.

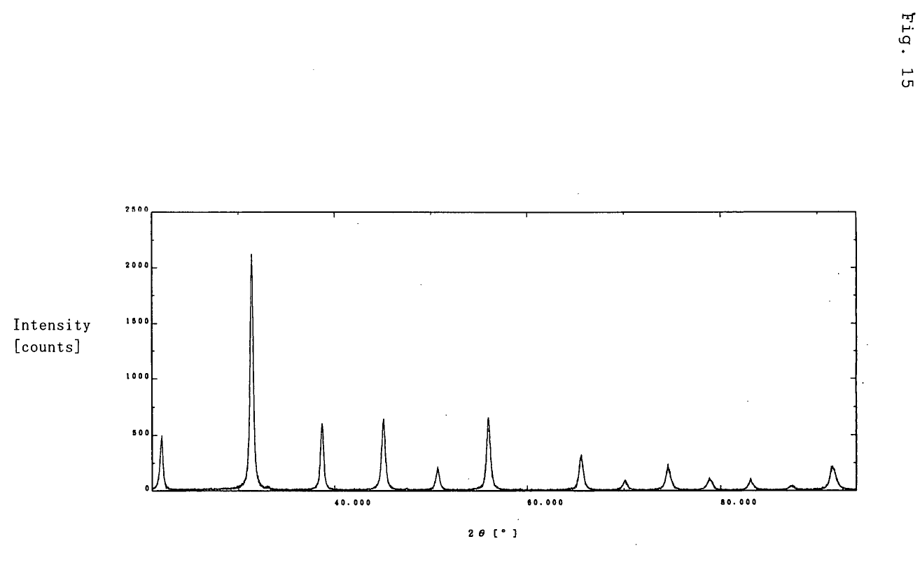

The reaction was continued until the total concentration of barium ion and calcium ion in the reaction solution became 1/1,000 or less of the amount charged. The ratio of the actual yield to the theoretical yield was 99.8%, the specific surface area was 38 m²/g, the particle was a perovskite Ba_{0.95}Ca_{0.05}TiO₃ composite. Also, the shape of the obtained powder particle was observed through a scanning electron microscope and found to be spherical as shown in FIG. 14. FIG. 15 shows the X-ray diffraction spectrum at this time.

D1 was 0.027 μm, D2 was 0.21 μm, and D2/D1 was 7.8. The total amount of barium carbonate and calcium carbonate contained in this powder particle was 0.4 mass %.

The dry powder was dissolved and the K ion amount was measured by the ICP emission method, as a result, 12 ppm of K ion was contained. Also, the Cl ion amount was measured by anion chromatography, as a result, 70 ppm of Cl ion was contained.

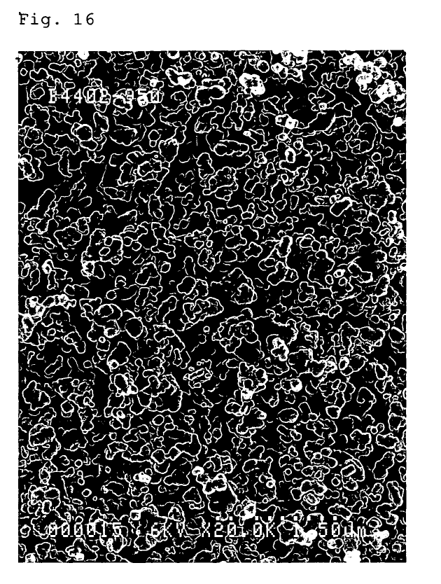

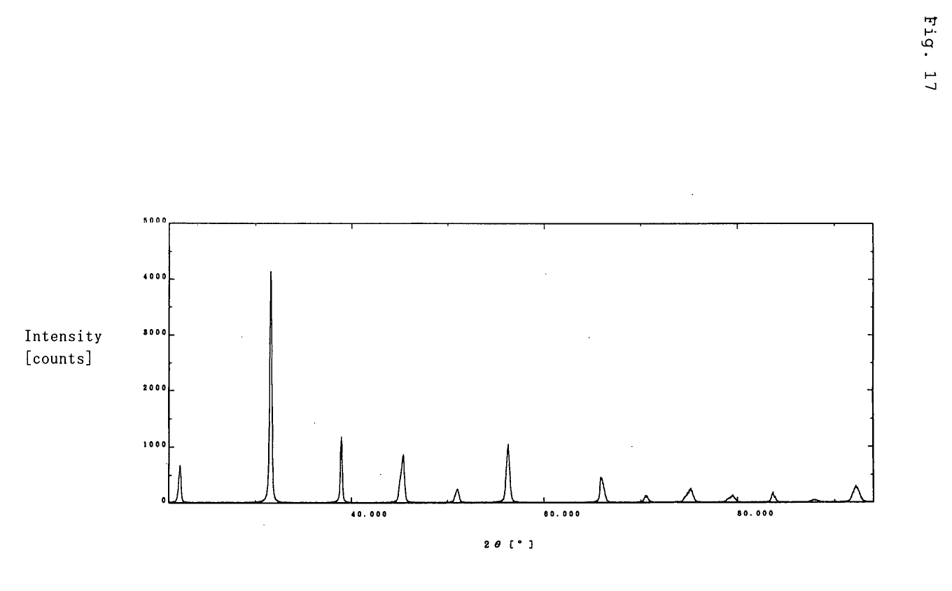

The total extracted amount of ions, calculated according to formula (3), was 0.21 μmol/m². After keeping at 950° C. for 2 hours, the specific surface area was 7 m²/g, the percentage decrease in the specific surface area, calculated according to formula (2), was 82%. Also, the shape of the obtained powder particle was observed through a scanning electron microscope and found to be spherical as shown in FIG. 16, and the particle was a single crystal. FIG. 17 shows the X-ray diffraction spectrum at this time.

### INDUSTRIAL APPLICABILITY

The perovskite titanium-containing composite oxide particle in the present invention has a small particle size, a narrow particle size distribution, excellent dispersibility, high crystallinity and excellent electrical properties.

Especially, the perovskite titanium-containing composite oxide particle of a small particle size with less impurities can be obtained by a method wherein A1(OH)₂ and A2(OH)₂ are reacted at an arbitrary ratio with titanium oxide in an alkaline solution containing a basic compound and then the basic compound can be removed by evaporation through thermal decomposition and the like and wherein two metal atoms (A1 and A2) at A sites can be solid-dissolved at an arbitrary ratio.

Furthermore, the calcium titanate particle obtained by reacting a titanium oxide sol with a calcium salt at saturated solubility or higher in an alkaline aqueous solution containing a basic compound has a property that the particle size distribution is extremely narrow with the number of ultrafine particles or aggregated particles being very small.

By using the perovskite titanium-containing composite oxide particle in the present invention, which exhibits excellent electrical properties, dielectric materials dielectric material, piezoelectric material and pyroelectric material, such as porcelain, thin film and dielectric film, having an excellent performance can be obtained. Further, use of these materials in electronics devices enables downsizing and reduction in weight of the devices.

1. A perovskite titanium-containing composite oxide fine particle represented by the formula: (A1_{X}A2_{(1-X)})_{Y}TiO_{3±δ} (wherein 0≦X≦1, 0.98≦Y≦1.02, 0≦δ≦0.05, A1 and A2 each is an atom selected from a group consisting of Ca, Sr, Ba, Pb and Mg and are different from each other), wherein the specific surface area is from 1 to 100 m²/g and the D2/D1 value is from 1 to 10, wherein D1 represents average primary particle size and D2 represents the average particle size of secondary particles.

2. The perovskite titanium-containing composite oxide fine particle as claimed in claim 1, which has a single crystal of perovskite titanium-containing composite oxide.

3. The perovskite titanium-containing composite oxide fine particle as claimed in claim 1 or 2, comprising a tetragonal prism shape or a shape analogous to tetragonal prism.

4. The perovskite titanium-containing composite oxide fine particle as claimed in claim 3, wherein the ratio of the long side to the short side of the crystal is from 1.1 to 6.

5. The perovskite titanium-containing composite oxide fine particle as claimed in claim 3, wherein the long side of the crystal is extending to the unit cell (010) plane.

6. The perovskite titanium-containing composite oxide fine particle as claimed in claim 1, wherein the D2/D1 value is from 1 to 3.

7. The perovskite titanium-containing composite oxide fine particle as claimed claim 1, wherein D3/D2 value is from 0.1 to 0.9 and D3 represents the particle size of secondary particles at 10% from the minimum.

8. The perovskite titanium-containing composite oxide fine particle as claimed in claim 1, wherein D4/D2 value is from 1.1 to 10 and D4 represents the particle size of secondary particles at 90% from the minimum.

9. The perovskite titanium-containing composite oxide fine particle as claimed in claim 1, wherein the compound represented by (A1_{X}A2_{(1-X)})_{Y}TiO_{3±δ} is CaTiO₃ and the calcium carbonate content is 3 mass % or less.

10. The perovskite titanium-containing composite oxide fine particle as claimed in claim 1, wherein the specific surface area is from 1 to 10 m²/g.

11. The perovskite titanium-containing composite oxide fine particle as claimed in claim 1, wherein calcining at any temperature of 900 to 1,200° C., the decrease in the specific surface area is 8 m²/g or less.

12. The perovskite titanium-containing composite oxide fine particle as claimed in claim 1, wherein 0.2≦X≦0.8, 0.99≦Y≦1.01, 0≦δ≦0.03 and the fine particle is a single crystal.

13. The perovskite titanium-containing composite oxide fine particle as claimed in claim 1, wherein A1 is Ba and A2 is Sr.

14. The perovskite titanium-containing composite oxide fine particle as claimed in claim 1, wherein the amount of alkali metal impurities is from 0 to 100 ppm and the amount of chlorine impurities is from 0 to 600 ppm.

15. The perovskite titanium-containing composite oxide fine particle as claimed in claim 1, wherein calcining for 0.1 to 3 hours at any temperature from 900 to 1,000° C., the percentage decrease in the specific surface area is 90% or less.

16. The perovskite titanium-containing composite oxide fine particle as claimed in claim 1, wherein the shape becomes a dice form after calcining for 0.1 to 3 hours at any temperature from 900 to 1,200° C.

17. The perovskite titanium-containing composite oxide fine particle as claimed in claim 1, wherein the amount of carbonate is 3 mass % or less.

18. The perovskite titanium-containing composite oxide fine particle as claimed in claim 1, wherein when 1.5 g of the perovskite titanium-containing composite oxide particle is immersed in 45 ml of pure water, the total extraction amount of A1 atom and A2 atom per unit surface area is from 0 to 2 μmol/m².

19. A process for producing the perovskite titanium-containing composite oxide fine particle as claimed in claim 1, wherein a titanium oxide sol and a metal salt are added into an alkaline aqueous solution comprising basic compound, and then react.

20. The process for producing the perovskite titanium-containing composite oxide fine particle as claimed in claim 19, wherein the metal salt is added in a weight of 10 to 10,000 times by mass the saturated solubility in an alkaline solution.

21. The process for producing the perovskite titanium-containing composite oxide fine particle as claimed in claim 19, wherein the calcium salt is a hydroxide.

22. The process for producing the perovskite titanium-containing composite oxide fine particle as claimed in claim 19, comprising controlling the concentration of a carbonic acid group in the reaction solution to 500 ppm or less in terms of CO₂.

23. The process for producing the perovskite titanium-containing composite oxide fine particle as claimed in claim 19, comprising a step of boiling the reaction system at 100° C. or more for 2 hours or more.

24. The process for producing the perovskite titanium-containing composite oxide fine particle as claimed in claim 19, which comprises a step of removing impurities as gas by evaporation and/or thermal decomposition under atmospheric or reduced pressure in the temperature range from room temperature to calcining temperature.

25. The process for producing the perovskite titanium-containing composite oxide fine particle as claimed in claim 19, wherein the titanium oxide sol is obtained by hydrolyzing titanium compounds in an acidic solution.

26. The process for producing the perovskite titanium-containing composite oxide fine particle as claimed in claim 19, wherein the titanium oxide sol comprises a brookite crystal.

27. The process for producing the perovskite titanium-containing composite oxide fine particle as claimed in claim 19, wherein the basic compound is a substance which becomes gas by evaporation, sublimation and/or thermal decomposition under atmospheric or reduced pressure.

28. The process for producing the perovskite titanium-containing composite oxide fine particle as claimed in claim 27, wherein the basic compound is an organic base.

29. The process for producing the perovskite titanium-containing composite oxide fine particle as claimed in claim 19, wherein the basic compound is a tetramethylammonium hydroxide.

30. A process for producing a perovskite titanium-containing composite oxide fine particle, comprising reacting A1(OH)₂ and A2(OH)₂ at an arbitrary ratio with titanium oxide of 0.98 to 1.02 mol times the total mol of A1(OH)₂ and A2(OH)₂ in an alkaline solution comprising a basic compound and having a pH of 10 or more, wherein A1 and A2 each represent an atom selected from a group consisting of Ca, Sr, Ba, Pb and Mg, continuing the reaction until the total concentration of A1 ion and A2 ion in the reaction solution becomes 1/1,000 or less of the amount added and after the completion of reaction, removing the basic compound as gas by evaporation, sublimation and/or thermal decomposition under atmospheric or reduced pressure in the temperature range from room temperature to calcining temperature.

31. The process for producing a perovskite titanium-containing composite oxide fine particle as claimed in claim 30, wherein the molar ratio of A1(OH)₂ to A2(OH)₂ is from 0.2 to 0.8.

32. The process for producing a perovskite titanium-containing composite oxide fine particle as claimed in claim 30, comprising controlling the concentration of a carbonic acid group in the reaction solution to a range from 0 to 500 ppm in terms of CO₂.

33. The process for producing a perovskite titanium-containing composite oxide fine particle as claimed in claim 30, wherein the titanium oxide comprises a brookite crystal.

34. The process for producing a perovskite titanium-containing composite oxide fine particle as claimed in claim 30, wherein the titanium oxide is obtained by hydrolyzing a titanium compound in an acidic solution.

35. The process for producing a perovskite titanium-containing composite oxide fine particle as claimed in claim 30, wherein the basic compound is a substance which becomes gas by evaporation, sublimation and/or thermal decomposition under atmospheric or reduced pressure.

36. The process for producing a perovskite titanium-containing composite oxide fine particle as claimed in claim 30, wherein the basic compound is an organic base.

37. The process for producing a perovskite titanium-containing composite oxide fine particle as claimed in claim 30, wherein the basic compound is a tetramethylammonium hydroxide.

38. A dielectric material comprising the perovskite titanium-containing composite oxide fine particle as claimed in claim 1.

39. A paste comprising the perovskite titanium-containing composite oxide fine particle as claimed in claim 1.

40. A slurry comprising the perovskite titanium-containing composite oxide fine particle as claimed in claim 1.

41. A thin-film material comprising the perovskite titanium-containing composite oxide fine particle as claimed in claim 1.

42. A dielectric porcelain comprising the perovskite titanium-containing composite oxide fine particle as claimed in claim 1.

43. A pyroelectric porcelain comprising the perovskite titanium-containing composite oxide fine particle as claimed in claim 1.

44. A piezoelectric porcelain comprising the perovskite titanium-containing composite oxide fine particle as claimed in claim 1.

45. A capacitor comprising the dielectric porcelain as claimed in claim 42.

46. An electronic device comprising the thin-film material claimed in claim 41.

47. A sensor comprising the thin-film material claimed in claim 41.

48. A dielectric film comprising the perovskite titanium-containing composite oxide fine particle as claimed in claim 1.

49. A capacitor comprising the dielectric film as claimed in claim 48.

50. An electronic device comprising the porcelain claimed in any one of claims 42 to 44.

51. An electronic device comprising the capacitor as claimed in claim 45.

52. A sensor comprising a porcelain as claimed in any one of claims 42 to 44.
